(19) United States
(12) Patent Application Publication
(10) Pub. No.: US 2025/0358766 A1
(43) Pub. Date: Nov. 20, 2025

(54) HANDLING MISMATCH OF ALLOWED SINGLE NETWORK SLICE SELECTION ASSISTANCE INFORMATION

(71) Applicant: Samsung Electronics Co., Ltd., Suwon-si (KR)

(72) Inventors: Danish Ehsan HASHMI, Bengaluru (IN); Lalith KUMAR, Bengaluru (IN)

(21) Appl. No.: 19/212,050

(22) Filed: May 19, 2025

(30) Foreign Application Priority Data
May 20, 2024 (IN) 202441039262
May 20, 2024 (IN) 202441039283
May 5, 2025 (IN) 202441039262

(51) Int. Cl. H04W 60/04; H04W 48/18; H04W 60/06; H04W 76/30

(52) U.S. Cl. CPC H04W 60/04; H04W 48/18; H04W 60/06; H04W 76/30

(57) ABSTRACT

The disclosure relates to a fifth-generation (5G) or sixth-generation (6G) communication system for supporting a higher data transmission rate. A method performed by a terminal in a communication system is provided. The method includes transmitting, to an access and mobility management function (AMF), a registration request message, receiving, from the AMF, a registration accept message for the registration request message, the registration accept message including information on an on-demand single network slice selection assistance information (S-NSSAI), the information on the on-demand S-NSSAI including the on-demand S-NSSAI and a value of a slice deregistration inactivity timer associated with the on-demand S-NSSAI, and in case that a condition is satisfied, starting the slice deregistration inactivity timer for the on-demand S-NSSAI over an access type, using the value. The condition is satisfied in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or in case that user plane resources of the MA PDU session are released over the access type, there is no PDU session associated with the on-demand S-NSSAI and there are no established user plane resources of the MA PDU session over the access type.

### CROSS-REFERENCE TO RELATED APPLICATION(S)

This application is based on and claims priority under 35 U.S.C. § 119(a) of an Indian Provisional patent application number 202441039262, filed on May 20, 2024, in the Indian Patent Office, of an Indian Provisional patent application number 202441039283, filed on May 20, 2024, in the Indian Patent Office, and of an Indian Non-Provisional patent application number 202441039262, filed on May 5, 2025, in the Indian Patent Office, the disclosure of each of which is incorporated by reference herein in its entirety.

### BACKGROUND

### 1. Field

The disclosure relates to the field of wireless communication network, network slices and mobility management. More particularly, the disclosure relates to methods and a user equipment (UE) for handling of allowed Single network slice selection assistance information with slice deregistration inactivity timer in a wireless communication network.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

A User equipment (UE) during a registration procedure may indicate in UE Mobility management (MM) core network capability that it supports UE configuration of network-controlled slice usage policy. Therefore, an Access and mobility management function (AMF) determines slice usage policy for a network slice for the UE and may configure the UE with this information together with configured network slice selection assistance information (NSSAI) in order to control usage of the network slice. For example, an on-demand single network slice selection assistance information (S-NSSAI) and a slice deregistration inactivity timer associated with the on-demand S-NSSAI are configured for the terminal to manage deregistration of a network slice associated with the on-demand S-NSSAI. As the slice deregistration inactivity timer is started in each of the UE and the AMF based on certain conditions, mismatch of running the slice deregistration inactivity timer between the UE and the AMF may occurs.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and a user equipment (UE) for handling of allowed Single network slice selection assistance information with slice deregistration inactivity timer in a wireless communication network.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes transmitting, to an access and mobility management function (AMF), a registration request message, receiving, from the AMF, a registration accept message for the registration request message, the registration accept message including information on an on-demand single network slice selection assistance information (S-NSSAI), the information on the on-demand S-NSSAI including the on-demand S-NSSAI and a value of a slice deregistration inactivity timer associated with the on-demand S-NSSAI, and in case that a condition is satisfied, starting the slice deregistration inactivity timer for the on-demand S-NSSAI over an access type, using the value. The condition is satisfied in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or in case that user plane resources of the MA PDU session are released over the access type, there is no PDU session associated with the on-demand S-NSSAI and there are no established user plane resources of the MA PDU session over the access type.

In accordance with another aspect of the disclosure, a method performed by an access and mobility management function (AMF) in a communication system is provided. The method includes receiving, from a terminal, a registration request message, determining information on an on-demand single network slice selection assistance information (S-NSSAI), the information on the on-demand S-NSSAI including the on-demand S-NSSAI and a value of a slice deregistration inactivity timer associated with the on-demand S-NSSAI, and transmitting, to the terminal, a registration accept message for the registration request message, the registration accept message including the information on the on-demand S-NSSAI. In case that a condition is satisfied, a first slice deregistration inactivity timer for the on-demand S-NSSAI over an access type is started in the terminal, based on the value. The condition is satisfied in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or in case that user plane resources of the MA PDU session are released over the access type, there is no PDU session associated with the on-demand S-NSSAI and there are no established user plane resources of the MA PDU session over the access type.

In accordance with another aspect of the disclosure, a terminal in a communication system is provided. The terminal includes a transceiver and a processor. The processor is configured to control the transceiver to transmit, to an access and mobility management function (AMF), a registration request message, control the transceiver to receive, from the AMF, a registration accept message for the registration request message, the registration accept message including information on an on-demand single network slice selection assistance information (S-NSSAI), the information on the on-demand S-NSSAI including the on-demand S-NSSAI and a value of a slice deregistration inactivity timer associated with the on-demand S-NSSAI, and in case that a condition is satisfied, start the slice deregistration inactivity timer for the on-demand S-NSSAI over an access type, using the value. The condition is satisfied in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or in case that user plane resources of the MA PDU session are released over the access type, there is no PDU session associated with the on-demand S-NSSAI and there are no established user plane resources of the MA PDU session over the access type.

In accordance with another aspect of the disclosure, an access and mobility management function (AMF) in a communication system is provided. The AMF includes a transceiver and a processor. The processor is configured to control the transceiver to receive, from a terminal, a registration request message, determine information on an on-demand single network slice selection assistance information (S-NSSAI), the information on the on-demand S-NSSAI including the on-demand S-NSSAI and a value of a slice deregistration inactivity timer associated with the on-demand S-NSSAI, and control the transceiver to transmit, to the terminal, a registration accept message for the registration request message, the registration accept message including the information on the on-demand S-NSSAI. In case that a condition is satisfied, a first slice deregistration inactivity timer for the on-demand S-NSSAI over an access type is started in the terminal, based on the value. The condition is satisfied in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or in case that user plane resources of the MA PDU session are released over the access type, there is no PDU session associated with the on-demand S-NSSAI and there are no established user plane resources of the MA PDU session over the access type.

In accordance with another aspect of the disclosure, a method for handling mismatch of an allowed Single network slice selection assistance information (S-NSSAI) in a wireless network is provided. The method includes configuring, by a User Equipment (UE), an on-demand S-NSSAI comprising a slice deregistration inactivity timer. Further, the method includes determining, by the UE, that a Multi-Access Protocol Data Unit (MA PDU) session associated with the on-demand S-NSSAI is released, a PDU session associated with the on-demand S-NSSAI is not available for a registered access, and an established user plane resource of the MA PDU session associated with the on-demand S-NSSAI is not present over the access. Further, the method includes starting, by the UE, the slice deregistration inactivity timer for the on-demand S-NSSAI over the access based on the determination. Further, the method includes handling mismatch of the allowed S-NSSAI in the wireless network based on the slice deregistration inactivity timer.

In an embodiment, the method includes stopping, by the UE, the slice deregistration inactivity timer. Further, the method includes determining, by the UE, that a user plane of the MA-PDU session associated with the S-NSSAI is successfully established over a corresponding access type. Further, the method includes resetting, by the UE, the slice deregistration inactivity timer in at least one of the UE and an Access and Mobility Management Function (AMF) entity when a user plane of the MA-PDU session associated with the S-NSSAI is successfully established over a corresponding access type.

In an embodiment, further, the method includes stopping, by the UE, the slice deregistration inactivity timer. Further, the method includes determining, by the UE, that the UE performs inter-system change from a N1 mode to a S1 mode and the UE successfully completes at least one of a tracking area update procedure and an attach request procedure. Further, the method includes resetting, by the UE, the slice deregistration inactivity timer in at least one of the UE and an AMF entity when the UE performs inter-system change from the N1 mode to the S1 mode and the UE successfully completes at least one of the tracking area update procedure and the attach request procedure.

In accordance with another aspect of the disclosure, a method for handling mismatch of an allowed S-NSSAI in a wireless network is provided. The method includes configuring, by a UE, an on-demand S-NSSAI comprising a slice deregistration inactivity timer. Further, the method includes determining, by the UE, that a user plane resource of a MA PDU session associated with the on-demand S-NSSAI is released on the access, a PDU session associated with the on-demand S-NSSAI is not present, and an established user plane resource of the MA PDU session associated with the on-demand S-NSSAI over the access is not present. Further, the method includes starting, by the UE, the slice deregistration inactivity timer for the on-demand S-NSSAI over the access based on the determination. Further, the method includes handling mismatch of the allowed S-NSSAI in the wireless network based on the slice deregistration inactivity timer.

In accordance with another aspect of the disclosure, a method for handling mismatch of an allowed S-NSSAI in a wireless network is provided. The method includes determining, by a UE, that an unavailability period is activated through a registration procedure. Further, the method includes starting, by the UE, a slice deregistration inactivity timer in the UE and an Access and Mobility Management Function (AMF) entity when the unavailability period is activated. Further, the method includes handling mismatch of the allowed S-NSSAI in the wireless network based on the slice deregistration inactivity timer.

In an embodiment, at least one Non-Access Stratum (NAS) timer is stopped and associated procedure associated with the at least one NAS timer is aborted except for slice deregistration inactivity timer and procedure associated with the slice deregistration inactivity timer.

In accordance with another aspect of the disclosure, a method for handling mismatch of an allowed S-NSSAI in a wireless network is provided. The method includes determining, by one of a UE and an AMF entity, that an on-demand S-NSSAI is added in a partially allowed NSSAI on an access type. Further, the method includes starting, by one of the UE and the AMF entity, a slice deregistration inactivity timer in the UE based on the determination. Further, the method includes handling mismatch of the allowed S-NSSAI in the wireless network based on the slice deregistration inactivity timer.

In an embodiment of the disclosure, the method includes stopping, by one of the UE and the AMF entity, the slice deregistration inactivity timer when a PDU session is established on the partially allowed NSSAI.

In an embodiment of the disclosure, the slice deregistration inactivity timer is stated by using a stored slice deregistration inactivity timer value.

In an embodiment of the disclosure, the partially allowed S-NSSAI is on-demand S-NSSAI.

In accordance with another aspect of the disclosure, a UE including an allowed S-NSSAI mismatch handling controller coupled with a processor and memory is provided. The allowed S-NSSAI mismatch handling controller is configured to configure an on-demand S-NSSAI comprising a slice deregistration inactivity timer. Further, the allowed S-NSSAI mismatch handling controller is configured to determine that a MA PDU session associated with the on-demand S-NSSAI is released, a PDU session associated with the on-demand S-NSSAI is not available for a registered access, and an established user plane resource of the MA PDU session associated with the on-demand S-NSSAI is not present over the access. Further, the allowed S-NSSAI mismatch handling controller is configured to start the slice deregistration inactivity timer for the on-demand S-NSSAI over the access based on the determination. Further, the allowed S-NSSAI mismatch handling controller is configured to handle mismatch of the allowed S-NSSAI in the wireless network based on the slice deregistration inactivity timer.

In accordance with another aspect of the disclosure, a UE including an allowed S-NSSAI mismatch handling controller coupled with a processor and memory is provided. The allowed S-NSSAI mismatch handling controller is configured to configure an on-demand S-NSSAI comprising a slice deregistration inactivity timer. Further, the allowed S-NSSAI mismatch handling controller is configured to determine that a user plane resource of a MA PDU session associated with the on-demand S-NSSAI is released on the access, a PDU session associated with the on-demand S-NSSAI is not present, and an established user plane resource of the MA PDU session associated with the on-demand S-NSSAI over the access is not present. Further, the allowed S-NSSAI mismatch handling controller is configured to start the slice deregistration inactivity timer for the on-demand S-NSSAI over the access based on the determination. Further, the allowed S-NSSAI mismatch handling controller is configured to handle mismatch of the allowed S-NSSAI in the wireless network based on the slice deregistration inactivity timer.

In accordance with another aspect of the disclosure, a UE including an allowed S-NSSAI mismatch handling controller coupled with a processor and memory is provided. The allowed S-NSSAI mismatch handling controller is configured to determine that an unavailability period is activated through a registration procedure. Further, the allowed S-NSSAI mismatch handling controller is configured to start a slice deregistration inactivity timer in the UE and an Access and Mobility Management Function (AMF) entity based on the determination. Further, the allowed S-NSSAI mismatch handling controller is configured to handle mismatch of the allowed S-NSSAI in the wireless network based on the slice deregistration inactivity timer.

In accordance with another aspect of the disclosure, a UE or an AMF entity including an allowed S-NSSAI mismatch handling controller coupled with a processor and memory is provided. The allowed S-NSSAI mismatch handling controller is configured to determine that an on-demand S-NSSAI is added in a partially allowed NSSAI on an access type. Further, the allowed S-NSSAI mismatch handling controller is configured to start a slice deregistration inactivity timer in the UE based on the determination. Further, the allowed S-NSSAI mismatch handling controller is configured to handle mismatch of the allowed S-NSSAI in the wireless network based on the slice deregistration inactivity timer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a sequence diagram for a scenario, where the inactivity deregistration timer was not started on user plane release, according to an embodiment of the disclosure;

FIG. 2 illustrates a sequence diagram of a scenario, where the inactivity deregistration timer was not stopped on user plane being established, according to an embodiment of the disclosure;

FIG. 3 illustrates a sequence diagram for a scenario, where the slice deregistration inactivity timer is not stopped when move to evolved packet core (EPC) or other radio access technology (RAT), according to an embodiment of the disclosure;

FIG. 4 illustrates a sequence diagram for a scenario, where the UE 102 and network may have the misaligned the slice deregistration inactivity timer for the on-demand S-NSSAI, according to an embodiment of the disclosure;

FIG. 5 illustrates a sequence diagram for a scenario, where the UE removes S-NSSAI from the allowed S-NSSAI locally, according to an embodiment of the disclosure;

FIG. 6 illustrates a sequence diagram, for a method for handling of N-SSAI mismatch in a wireless network, when a user plane corresponding to a PDU session is released, according to an embodiment of the disclosure;

FIG. 7 illustrates a sequence diagram, for a method for handling of N-SSAI mismatch in a wireless network, for a scenario where slice deregistration inactivity timer corresponding to an on-demand S-NSSAI is stopped, on a user plane being established, according to an embodiment of the disclosure;

FIG. 8 illustrates a sequence diagram, for a method for handling of N-SSAI mismatch in a wireless network, for a scenario, where inactivity deregistration timer is not stopped when a UE moves to EPC or any other RAT, according to an embodiment of the disclosure;

FIG. 9 illustrates a sequence diagram, for a method for handling of N-SSAI mismatch in a wireless network, for a scenario, where an AMF removes a S-NSSAI from the allowed NSSAI, according to an embodiment of the disclosure;

FIG. 10 illustrates a sequence diagram, for a method for handling of N-SSAI mismatch in a wireless network, for a scenario, where a UE removes S-NSSAI from the allowed S-NSSAI locally, according to an embodiment of the disclosure;

FIG. 11 illustrates a block diagram of a UE, for handling mismatch of an allowed single network slice selection assistance information (S-NSSAI) in a wireless network, according to an embodiment of the disclosure;

FIG. 12 illustrates a block diagram of an AMF, for handling mismatch of allowed S-NSSAI in a wireless network, according to an embodiment of the disclosure;

FIG. 13 illustrates a method for handling, for handling mismatch of the allowed S-NSSAI in the wireless network, according to an embodiment of the disclosure;

FIG. 14 illustrates a method for handling, for handling mismatch of the allowed S-NSSAI in the wireless network, according to an embodiment of the disclosure;

FIG. 15 illustrates a method for handling, for handling mismatch of the allowed S-NSSAI in the wireless network, according to an embodiment of the disclosure;

FIG. 16 illustrates a method for handling, for handling mismatch of the allowed S-NSSAI in the wireless network, according to an embodiment of the disclosure; and

FIG. 17 illustrates a method for handling, for handling mismatch of an allowed S-NSSAI in the wireless network for an unavailability period of UE, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The term “AMF-1” and “first AMF entity” are used interchangeably in the patent disclosure. The term “AMF-2” and “second AMF entity” are used interchangeably in the patent disclosure.

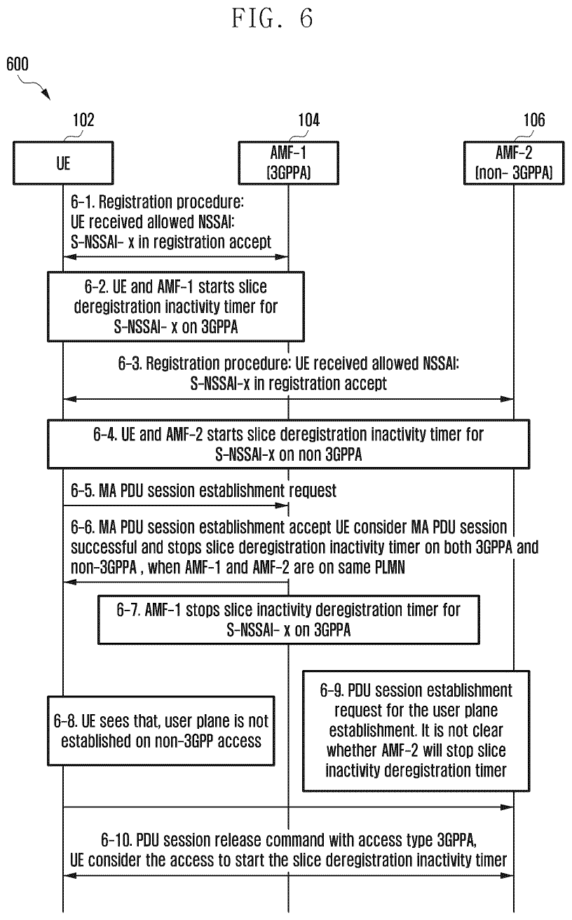

The embodiments herein achieve methods and systems for handling mismatch of allowed S-NSSAI in a wireless network. Referring now to the drawings, and more particularly to FIGS. 6 through 14, where similar reference characters denote corresponding features consistently throughout the figures, there are shown embodiments.

The following definitions and abbreviations have been referred to herein:
UP: User Plane
AMF: Access and Mobility Management Function
SMF: Session Management Function
UPF: User Plane Function
PCF: Policy Control Function
PDU: Protocol Data Unit
SR: Service Request
TAI: Tracking Area Identity
TAC: Tracking Area Code
3GPPA: 3GPP Access
N3GPPA: Non 3GPP Access
3GPP: 3^{rd} generation partnership project
MA PDU: Multi Access-PDU
RAT: Radio Access Technology
DL: Downlink
NAS: Non Access Stratum
MME: Mobility management entity
EPC: Evolved packet core
EPS: Evolved packet system.

The term 5GMM sublayer states in this embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
   g) 5GMM-DEREGISTERED.eCALL-INACTIVE
   h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

5GMM-IDLE mode: In this specification, if the term is used standalone, a UE in 5GMM-IDLE mode means the UE can be either in 5GMM-IDLE mode over 3GPP access or in 5GMM-IDLE mode over non-3GPP access.

5GMM-CONNECTED mode: In this specification, if the term is used standalone, a UE in 5GMM-CONNECTED mode means the UE can be either in 5GMM-CONNECTED mode over 3GPP access or in 5GMM-CONNECTED mode over non-3GPP access.

5GMM-IDLE mode over 3GPP access: A UE is in 5GMM-IDLE mode over 3GPP access when no N1 NAS signalling connection between the UE and network over 3GPP access exists. The term 5GMM-IDLE mode over 3GPP access used in the document corresponds to the term CM-IDLE state for 3GPP access used in 3GPP TS 23.501.

5GMM-CONNECTED mode over 3GPP access: A UE is in 5GMM-CONNECTED mode over 3GPP access when an N1 NAS signalling connection between the UE and network over 3GPP access exists. The term 5GMM-CONNECTED mode over 3GPP access used in the document corresponds to the term CM-CONNECTED state for 3GPP access used in 3GPP TS 23.501.

As described in 3GPP TS 23.501, a User equipment (UE) during a registration procedure may indicate in UE Mobility management (MM) core network capability that it supports UE configuration of network-controlled slice usage policy. Therefore, an Access and mobility management function (AMF) determines slice usage policy for a network slice for the UE and may configure the UE with this information together with configured NSSAI in order to control usage of the network slice. The AMF may be locally configured with network slice usage policy or receive the policy from an AMF Policy Control Function (PCF).

The network-controlled slice usage policy is provided to the UE in a registration accept or a UE configuration update command (in the on-demand NSSAI information elements (IE) which contains one or more on-demand S-NSSAIs and the associated slice deregistration inactivity timer value per the on-demand S-NSSAI to the UE specified in the TS 24.501), wherein the command may include an indication, for one or more of S-NSSAI(s) of a Home public Land mobile network (HPLMN) in the configured NSSAI, whether the UE needs to register a network slice from them with the network when applications running in the UE require data transmission in the network slice (i.e., the UE needs to register the network slice only on demand). Other network slices in the configured NSSAI are handled by the UE using UE specific policies (e.g. they can be registered irrespective of applications need).

For on demand S-NSSAI(s) of the HPLMN in the configured NSSAI, a slice deregistration inactivity timer causes the UE to deregister the Network Slice after the last PDU Session associated with the S-NSSAI is released. This slice deregistration inactivity timer is started at the UE and AMF for a registration access type when a last PDU session associated with the on demand S-NSSAI is released or, the network slice (i.e. on demand S-NSSAI) is included in the Allowed NSSAI with no PDU session is established. The slice deregistration inactivity timer is stopped and reset, when the first PDU session is established or the S-NSSAI is removed from the Allowed NSSAI. The AMF and UE may locally remove the S-NSSAI from the Allowed NSSAI when the slice deregistration inactivity timer expires. The AMF may also send a UE Configuration Update Command to remove the slice from the Allowed NSSAI.

The UE stores received slice usage policy with a configured NSSAI for the serving PLMN and this is kept stored for as long as a configured NSSAI remains stored for the PLMN. When the configured NSSAI is updated, the AMF may also provide a new slice usage policy to the UE.

If, the slice deregistration inactivity timer value is updated and the AMF determines to provide the timer to the UE, the AMF provides the updated value of the timer to the UE. Here, the UE supports UE configuration of network-controlled slice usage policy, during registration procedure or any subsequent registration procedure when there is no ongoing registration procedure. When the update been provided to the UE successfully, the AMF and the UE, use the updated slice deregistration inactivity timer value for next time when the slice deregistration inactivity timer starts.

A PDU Session inactivity timer is provided by session management functions (SMFs) to User plane functions (UPFs) which handle PDU sessions in the network slice. The PDU session inactivity timer is started after no data packet is transmitted or received and runs until the next data packet is transmitted or received which restarts the PDU session inactivity timer again. If the PDU Session inactivity timer expires before any packet is received or transmitted, the UPF reports this PDU Session inactivity event to the SMF to cause the SMF to release the PDU session. When the AMF receives the notification of PDU Session release and it includes the indication of network slice removal and if the network slice of the released PDU Session is not used by other PDU sessions (i.e. the last PDU session using the network slice is released) over the corresponding access type, the AMF may trigger the UE configuration update procedure to remove the network slice from the allowed NSSAI over the corresponding access type.

The slice deregistration inactivity timer and PDU Session inactivity timers are either pre-configured in the AMF (or SMF) or received from the Policy control function (PCF) (or UDM).

If the UE and network supports unavailability period and an event is triggered in the UE for which the UE is unavailable for a certain period of time, the UE may store its 5GMM and 5GSM context in universal subscriber identity module (USIM) or non-volatile memory in Mobile equipment (ME) to be able to reuse it after the unavailability period.

How and where the UE stores its contexts depends upon the UE implementation. The UE can store some or all of its contexts in the ME or USIM using existing ME or USIM functionality.

To activate the unavailability period, either the UE provides unavailability information, including a type of unavailability, an unavailability period duration if known, and the start of the unavailability period if known, during the registration procedure. Further, to activate the unavailability period the UE provides unavailability information including the type of unavailability and the unavailability period duration if known, during the de-registration procedure (as described in 3GPP TS 23.501 and 3GPP TS 23.502). The support for the unavailability period is negotiated in the registration procedure. If the UE is registered to a PLMN via a satellite NG-RAN cell, the AMF may provide the unavailability period duration of the UE or the start of the unavailability period or both to the UE during the registration procedure. The AMF may consider the unavailability period duration provided by the UE if available and determine the unavailability period duration of the UE as described in subclause 5.5.1.2.4 and 5.5.1.3.4 of 3GPP TS 24.501. The AMF may also consider the start of the unavailability period provided by the UE, if available, and determine the start of the unavailability period of the UE as described in subclause 5.5.1.3.4 of 3GPP TS. 24.501.

The user plane established for the MA PDU session is specified in TS 24.193 as below:

### 5.2.1 Activation of Multi-Access PDU Connectivity Service

Activating multi-access PDU connectivity service refers to the establishment of user-plane resources on both 3GPP access and non-3GPP access:
a) if the UE is registered over both 3GPP access and non-3GPP access in the same PLMN, the UE shall initiate the UE-requested PDU session establishment procedure as specified in clause 6.4.1.2 of 3GPP TS 24.501 over a selected access, either 3GPP access or non-3GPP access. Over which access to initiate this UE-requested PDU session establishment procedure is UE implementation specific. When the UE receives the PDU SESSION ESTABLISHMENT ACCEPT message including the ATSSS container IE as specified in clause 6.4.1.3 of 3GPP TS 24.501, the UE shall consider that the MA PDU session has been established and the user plane resources are successfully established on the selected access. When the user plane resources are established on the access other than the selected access (e.g. received lower layer indication in 3GPP access or established user plane IPsec SA in untrusted non-3GPP access), the UE shall consider the user plane resources are established on both;

NOTE: If the UE receives the PDU SESSION ESTABLISHMENT ACCEPT message including the ATSSS container IE and fails to receive user plane resources established on the access other than the selected access, upon an implementation specific timer expiry the UE re-initiates the UE-requested PDU session establishment procedure over the access other than the selected access, in order to establish user plane resources on the access other than the selected access.
b) if the UE is registered over both 3GPP access and non-3GPP access in different PLMNs, the UE shall initiate the UE-requested PDU session establishment procedure as specified in clause 6.4.1.2 of 3GPP TS 24.501 over 3GPP access and non-3GPP access sequentially. Over which access to first initiate the UE-requested PDU session establishment procedure is UE implementation specific. When the UE receives the PDU SESSION ESTABLISHMENT ACCEPT message including the ATSSS container IE as specified in clause 6.4.1.3 of 3GPP TS 24.501 over the selected access, the UE shall consider that the MA PDU session has been established and the user plane resources of the MA PDU session on this access are successfully established. The UE shall then initiate the UE-requested PDU session establishment procedure with the same PDU session ID, as specified in clause 6.4.1.2 of 3GPP TS 24.501 over the other access, in order to establish user plane resources on the other access for the MA PDU session. If the UE receives the PDU SESSION ESTABLISHMENT ACCEPT message as specified in clause 6.4.1.3 of 3GPP TS 24.501 over the other access, the UE shall consider that the user plane resources of the MA PDU session have been established on both 3GPP access and non-3GPP access; or
c) if the UE is registered to a PLMN over only one access, either 3GPP access or non-3GPP access, the UE shall initiate the UE-requested PDU session establishment procedure as specified in clause 6.4.1.2 of 3GPP TS 24.501 over this access. When the UE receives the PDU SESSION ESTABLISHMENT ACCEPT message including the ATSSS container IE as specified in clause 6.4.1.3 of 3GPP TS 24.501 over the access, the UE shall consider that the MA PDU session has been established and the user plane resources of the MA PDU session on this access are successfully established. When the UE at a later point in time registers over the other access, either in the same PLMN or in a different PLMN, the UE shall initiate the UE-requested PDU session establishment procedure with the same PDU session ID as specified in clause 6.4.1.2 of 3GPP TS 24.501 over the other access in order to establish user plane resources on the other access for the MA PDU session. If the UE receives the PDU SESSION ESTABLISHMENT ACCEPT message as specified in clause 6.4.1.3 of 3GPP TS 24.501 over the other access, the UE shall consider that the user plane resources of the MA PDU session have been established over both 3GPP access and non-3GPP access.
   5.2.5 Converting PDU Session Transferred from EPS to MA PDU Session

When an ATSSS capable UE has transferred a PDN connection from S1 mode to N1 mode in the network supporting N26 interface and the related URSP or UE local configuration does not mandate the PDU session shall be established over a single access:
a) if the UE is registered over both 3GPP access and non-3GPP access in the same PLMN, and the S-NSSAI associated with the PDU session over 3GPP access is included in the allowed NSSAI of non-3GPP access, the UE may initiate the UE-requested PDU session modification procedure by sending the PDU SESSION MODIFICATION REQUEST message including 5GSM capability IE over 3GPP access as specified in clause 6.4.2.2 of 3GPP TS 24.501. The UE may set the Request type IE to either:
1) “modification request” and include the MA PDU session information IE set to “MA PDU session network upgrade is allowed” as defined in clause 9.11.3.31A of 3GPP TS 24.501; or
2) “MA PDU request”
   in the UL NAS TRANSPORT message as specified in clause 8.2.10 of 3GPP TS 24.501. When the UE receives the PDU SESSION MODIFICATION COMMAND message including the ATSSS container IE as specified in clause 6.4.2.3 of 3GPP TS 24.501, the UE shall consider that the requested PDU session was converted by the network to an MA PDU session and the user plane resources are successfully established on 3GPP access. When the user plane resources are established on the non-3GPP access (e.g., received established user plane IPsec SA in untrusted non-3GPP access), the UE shall consider the user plane resources are established on both accesses;

NOTE: If the UE receives the PDU SESSION MODIFICATION COMMAND message including the ATSSS container IE and fails to receive user plane resources established on the non-3GPP access, upon an implementation specific timer expiry the UE initiates the UE-requested PDU session establishment procedure over the non-3GPP access, in order to establish user plane resources on the non-3GPP access.
b) if the UE is registered over both 3GPP access and non-3GPP access in different PLMNs, the UE may initiate the UE-requested PDU session modification procedure by sending the PDU SESSION MODIFICATION REQUEST message including 5GSM capability IE over 3GPP access as specified in clause 6.4.2.2 of 3GPP TS 24.501. The UE may set the Request type IE to either:
1) “modification request” and include the MA PDU session information IE set to “MA PDU session network upgrade is allowed” as defined in clause 9.11.3.31A of 3GPP TS 24.501; or
2) “MA PDU request”
   in the UL NAS TRANSPORT message as specified in clause 8.2.10 of 3GPP TS 24.501. When the UE receives the PDU SESSION MODIFICATION COMMAND message including the ATSSS container IE as specified in clause 6.4.2.3 of 3GPP TS 24.501, the UE shall consider that the requested PDU session was converted by the network to an MA PDU session and the user plane resources are successfully established on 3GPP access. The UE shall then initiate the UE-requested PDU session establishment procedure with the same PDU session ID, as specified in clause 6.4.1.2 of 3GPP TS 24.501 over non-3GPP access, in order to establish user plane resources on the other access for the MA PDU session; or
c) if the UE is registered over 3GPP access only, the UE may initiate the UE-requested PDU session modification procedure by sending the PDU SESSION MODIFICATION REQUEST message including 5GSM capability IE over 3GPP access as specified in clause 6.4.2.2 of 3GPP TS 24.501, the UE may set the Request type IE to either:
1) “modification request” and include the MA PDU session information IE set to “MA PDU session network upgrade is allowed” as defined in clause 9.11.3.31A of 3GPP TS 24.501; or
2) “MA PDU request”
   in the UL NAS TRANSPORT message as specified in clause 8.2.10 of 3GPP TS 24.501. When the UE receives the PDU SESSION MODIFICATION COMMAND message including the ATSSS container IE as specified in clause 6.4.2.3 of 3GPP TS 24.501, the UE shall consider that the requested PDU session was converted by the network to an MA PDU session and the user plane resources are successfully established on 3GPP access. When the UE at a later point in time registers over the non-3GPP access, either in the same PLMN or in a different PLMN, the UE shall initiate the UE-requested PDU session establishment procedure with the same PDU session ID as specified in clause 6.4.1.2 of 3GPP TS 24.501 over non-3GPP access in order to establish user plane resources on non-3GPP access for the MA PDU session.
      5.2.6 PDU Session Establishment with Network Modification to MA PDU Session

When an ATSSS capable UE establishes a new PDU session and the related URSP or UE local configuration does not mandate the PDU session shall be established over a single access:
a) if the UE is registered over both 3GPP access and non-3GPP access in the same PLMN and the UE initiates the UE-requested PDU session establishment procedure over a selected access, either 3GPP access or non-3GPP access, the UE may include the MA PDU session information IE in the UL NAS TRANSPORT message and set the IE to “MA PDU session network upgrade is allowed” as defined in clause 9.11.3.31A of 3GPP TS 24.501. When the UE receives the PDU SESSION ESTABLISHMENT ACCEPT message including the ATSSS container IE as specified in clause 6.4.1.3 of 3GPP TS 24.501, the UE shall consider that the requested PDU session is established as an MA PDU session and the user plane resources are successfully established on the selected access. When the user plane resources are established on the access other than the selected access (e.g. received lower layer indication in 3GPP access or established user plane IPsec SA in untrusted non-3GPP access), the UE shall consider the user plane resources are successfully established on both accesses;

NOTE: If the UE receives the PDU SESSION ESTABLISHMENT ACCEPT message including the ATSSS container IE and fails to receive user plane resources established on the access other than the selected access, upon an implementation specific timer expiry the UE re-initiates the UE-requested PDU session establishment procedure over the access other than the selected access, in order to establish user plane resources on the access other than the selected access.
b) if the UE is registered over both 3GPP access and non-3GPP access in different PLMNs and the UE initiates the UE-requested PDU session establishment procedure over 3GPP access or non-3GPP access, the UE may include the MA PDU session information IE in the UL NAS TRANSPORT message and shall set the IE to “MA PDU session network upgrade is allowed” as defined in clause 9.11.3.31A of 3GPP TS 24.501. When the UE receives the PDU SESSION ESTABLISHMENT ACCEPT message including the ATSSS container IE as specified in clause 6.4.1.3 of 3GPP TS 24.501 over the access, the UE shall consider that the requested PDU session is established as an MA PDU session and the user plane resources are established on this access. The UE shall then initiate the UE-requested PDU session establishment procedure with the same PDU session ID, as specified in clause 6.4.1.2 of 3GPP TS 24.501 over the other access, in order to establish user plane resources on the other access for the MA PDU session. If the UE receives the PDU SESSION ESTABLISHMENT ACCEPT message including the ATSSS container IE as specified in clause 6.4.1.3 of 3GPP TS 24.501 over the other access, the UE shall consider that the user plane resources of the MA PDU session have been established on both 3GPP access and non-3GPP access; or
c) if the UE is registered to a PLMN over only one access, either 3GPP access or non-3GPP access, and the UE requests to establish a PDU session over this access, the UE may include the MA PDU session information IE in the UL NAS TRANSPORT message and shall set the IE to “MA PDU session network upgrade is allowed” as defined in clause 9.11.3.31A of 3GPP TS 24.501. When the UE receives the PDU SESSION ESTABLISHMENT ACCEPT message including the ATSSS container IE as specified in clause 6.4.1.3 of 3GPP TS 24.501 over the access, the UE shall consider that the requested PDU session is established as an MA PDU session and the user plane resources are established on this access. When the UE at a later point in time registers over the other access, either in the same PLMN or in a different PLMN, the UE shall initiate the UE-requested PDU session establishment procedure with the same PDU session ID as specified in clause 6.4.1.2 of 3GPP TS 24.501 over the other access in order to establish user plane resources on the other access for the MA PDU session. If the UE receives the PDU SESSION ESTABLISHMENT ACCEPT message including the ATSSS container IE as specified in clause 6.4.1.3 of 3GPP TS 24.501 over the other access, the UE shall consider that the user plane resources of the MA PDU session have been established on both 3GPP access and non-3GPP access.

If the UE provided unavailability information in last registration procedure for mobility registration or de-registration, the AMF considers the UE unreachable until the UE registers for a normal service. If the UE did not include a start of the unavailability period, the AMF shall consider the start of the unavailability period to be the time at which AMF received the REGISTRATION REQUEST message or the DEREGISTRATION REQUEST message from the UE. During the registration procedure, the AMF may determine the values of negotiated extended DRX parameters, a timer T3324, and a periodic registration update timer (T3512) to be provided to the UE based on the unavailability period duration and the start of the unavailability period based on their availability. The AMF should set the value of the mobile reachable timer and implicit de-registration timer based on the unavailability period duration and the start of the unavailability period. The AMF releases the N1 signaling connection after the completion of the registration procedure in which the UE provided unavailability information without providing start of the unavailability period.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

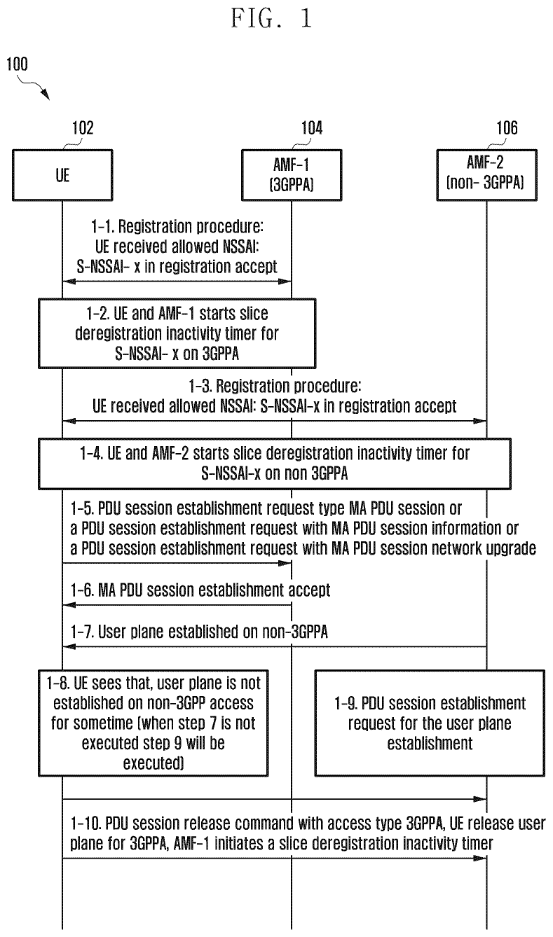

FIG. 1 illustrates a sequence diagram 100 for a scenario, where the inactivity deregistration timer was not started on user plane release, according to an embodiment of the disclosure.

Considering that the S-NSSAI-x is an on-demand S-NSSAI with associated slice deregistration inactivity timer for each access types 3GPPA and non-3GPPA. The on-demand S-NSSAI can come in on-demand NSSAI IE along with the registration accept or UE configuration update command NAS message or any other downlink NAS massage. Also, consider that there is no other PDU session is associated with S-NSSAI-x.

In operation 1-1, in the registration procedure, the UE 102 receives allowed NSSAI: S-NSSAI-x in the registration accept in 3GPPA. In operation 1-2, the UE 102 and an AMF-1 (or first AMF entity) 104 will start slice deregistration inactivity timer for S-NSSAI-x on 3GPPA. In operation 1-3, in the registration procedure, the UE 102 receives allowed NSSAI: S-NSSAI-x in the registration accept on non-3GPPA. In operation 1-4, the UE 102 and the AMF-2 (or second AMF entity) 106 will start slice deregistration inactivity timer for S-NSSAI-x on non-3GPPA. In operation 1-5, the AMF-1 104 allows a PDU session establishment request type MA PDU session or a PDU session establishment request with MA PDU session information or a PDU session establishment request with MA PDU session network upgrade. In operation 1-6, the PDU session establishment accept is received by the AMF-1 104 with ATSSS parameters, where the UE 102 consider MA PDU session establishment successful, the UE 102 stops the slice deregistration inactivity timer for both 3GPP and non-3GPP access, the AMF-1 104 only stops the slice deregistration inactivity timer associated with 3GPPA. In operation 1-7, the AMF-2 106 stops slice deregistration inactivity timer for S-NSSAI-X associated with non-3GPP access (if user plane established for non-3GPP access). In operation 1-8, the UE 102 sees that user plane is not established on non-3GPP access (i.e. UE 102 failed to get the user plane establishment indication for an implementation specific timer expiry on non-3GPP access after the PDU session establishment accept received on 3GPP access or PDU session modification received on 3GPP access with ATSSS container IE). In operation 1-9, the PDU session establishment request is sent to the AMF-2 106 for a user plane establishment (if operation 1-7 does not happen). However, it is not specified whether AMF-2 106 will stop slice inactivity timer here. In operation 1-10, the AMF-1 104 releases the PDU session through a PDU session release command with access type 3GPPA. The UE 102 releases user plane for 3GPPA, MA PDU session will continue, and the UE 102 will not start the timer but AMF-1 104 will start as it will see no PDU session associated with the S-NSSAI-x.

In case of MA PDU session established where 3GPPA and non-3GPPA are at the different PLMN, the user plane will not be established on both the access at the PDU session establishment procedure. It is not clear currently whether the UE considers stopping the timer when MA PDU session is established on both the access and UE stops the timer when user plane is established on the other access where PDU session establishment is not sent.

When the UE 102 is served by the different AMFs on 3GPP and non-3GPP and user plane is deactivated for the access by including access type in the PDU session release command. In this case, the AMF of corresponding access will start slice deregistration inactivity timer for the access but as the PDU session is still MA PDU session so UE will not start the timer. These lead to the running slice deregistration timer mismatch at the UE 102 and the network.

The synchronization issue will also come in the case, when UE is registered on one access (non-3GPPA) and initiated PDU session establishment request/PDU session modification request type MA PDU request or modification request” and include the MA PDU session information IE set to “MA PDU session network upgrade is allowed. Network indicated ATSSS container in the PDU session establishment accept or PDU session modification command. UE deems that MA PDU session is established (or converted to MA PDU session. UE will stop (or reset) slice deregistration inactivity timer for now, wherein the UE is registered on the other access (say 3GPPA) then UE will not start slice deregistration inactivity timer for the 3GPPA as MA PDU session is established. But the AMF sees that there is no PDU session associated with S-NSSAI-x and start slice de-registration timer.

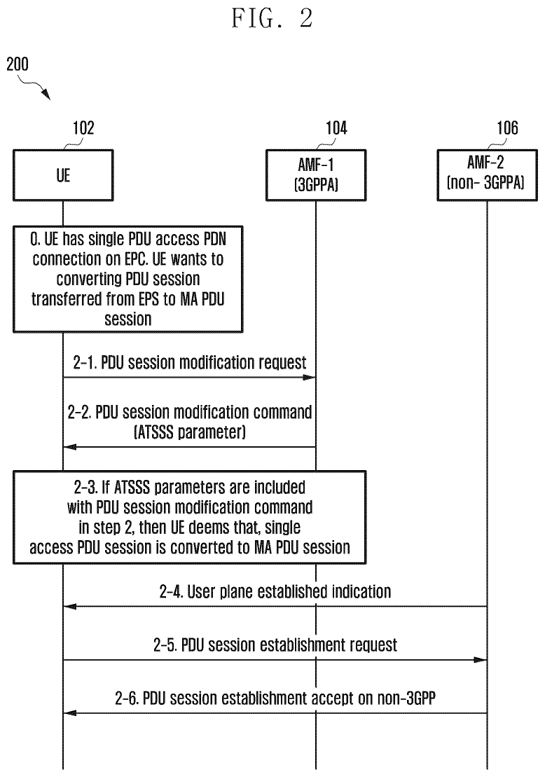

FIG. 2 illustrates a sequence diagram 200 of a scenario, where the inactivity deregistration timer was not stopped on user plane being established, according to an embodiment of the disclosure.

The UE 102 has a single PDU access Packet data network (PDN) connection on Evolved packet core (EPC). A network slice S-NSSAI-x is in allowed NSSAI in non-3GPP and is on-demand on both 3GPP and non-3GPP access. The UE wants to convert the PDU session transferred from EPS (or PEC) to MA PDU session.

At operation 2-1, the UE 102 sends a PDU session modification request with ATSSS parameters to the AMF-1 104. The UE 102 may set the Request type IE to either:
a) modification request” and include the MA PDU session information IE set to “MA PDU session network upgrade is allowed” as defined in clause 9.11.3.31A of 3GPP TS 24.501; or
b) “MA PDU request.”

At operation 2-2, when the network deems that MA PDU session can be converted, it sends the PDU session medication command with ATSSS parameters.

At operation 2-3, the UE 102 considers that as single PDU session is upgraded to the MA PDU session. If 3GPP and non-3GPP are on the same PLMN then UE may receive the user plane setup indication. In this case the UE 102 is not stopping the slice deregistration inactivity timer running on the non-3GPP for the S-NSSAI-x.

At operation 2-4, the UE 102 received user plane established indication on non-3GPP access from the AMF-2. At operation 2-5, the UE 102 sends a PDU session establishment request to the AMF-2.

At operation 2-6, the AMF-2 106 sends a PDU session establishment accept message to the UE. User plane is established on non-3GPPA. The UE 102 initiates the PDU session establishment procedure to setup the user plane on non-3GPP access, if the UE 102 has not received user plane setup indication for some time (when UE is on same PLMN in 3GPP and non-3GPP) or when the UE 102 is on the different PLMN on 3GPPA and non-3GPPA then.

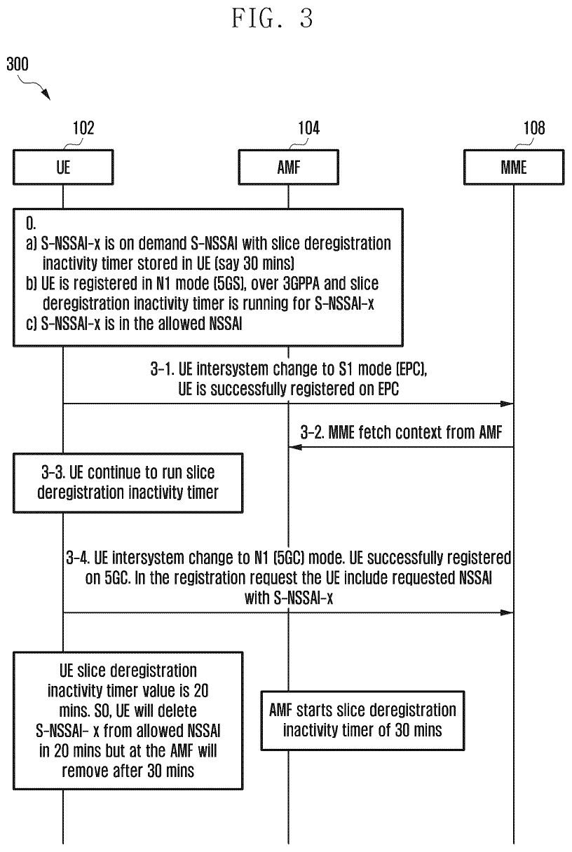

FIG. 3 illustrates a sequence diagram 300 for a scenario, where the slice deregistration inactivity timer is not stopped when move to EPC or other RAT, according to an embodiment of the disclosure.

The S-NSSAI-x is on-demand S-NSSAI with slice deregistration inactivity timer stored in the UE (say 30 mins). The UE 102 is registered in N1 mode (in 5GS) over 3GPPA and slice deregistration timer is running for S-NSSAI-x. The S-NSSAI-x is in the allowed NSSAI.

At operation 3-1, the UE 102 intersystem changes to EPC, and tracking area update is successfully performed.

At operation 3-2, the MME 108 fetches the context from the AMF 104 (N26 is supported). The MME 108 cannot fetch the running slice inactivity deregistration timer. In this case, the AMF 104 can maintain context for some time based on the implementation but it is not specified if the slice inactivity deregistration shall be running or stopped.

As per the current state of art, at operation 3-3, the UE 102 will continue with the running slice deregistration inactivity timer. At operation 3-4, the UE intersystem changes to the N1 mode (5GC). The AMF sends the allowed NSSAI (S-NSSAI-1) to the UE 102. It is not specified if the AMF will start a new timer.

If the AMF 104 stops the running timer and the UE continues with the running timer then there will be misalignment of the slice deregistration timer between the UE and the AMF, when the UE is back to N1 mode.

When, the S-NSSAI-x is in allowed NSSAI on 3GPPA and PDU session has not been established on S-NSSAI-x, the UE and the AMF will start slice inactivity deregistration timer for the S-NSSAI-x.

Now, the UE inter-system again changes from 5GS/NR/5G Radio access (N1 mode) to EPC (S1 mode) or other RAT (UTRAN/GERAN). When the UE moves to other access, the AMF behavior for the slice inactivity de-registration timer has not been specified.

The allowed NSSAI is not deleted when the UE moves to EPC or other access technology from 5GS so slice deregistration timer associated with S-NSSAI-x will continue to run in the UE. When the UE comeback again to 5GS then there will be mismatch of running slice deregistration inactivity timer between UE and the AMF.

Consider that the S-NSSAI-x is on-demand NSSAI, the AMF includes the S-NSSAI-x in the allowed NSSAI. The UE and the AMF starts the slice deregistration inactivity timer. The UE receives the partially S-NSSAI-x as partially allowed NSSAI. As per the current state of art even after slice deregistration timer expiry, the UE will only remove the S-NSSAI-x from allowed NSSAI not from the partially allowed NSSAI.

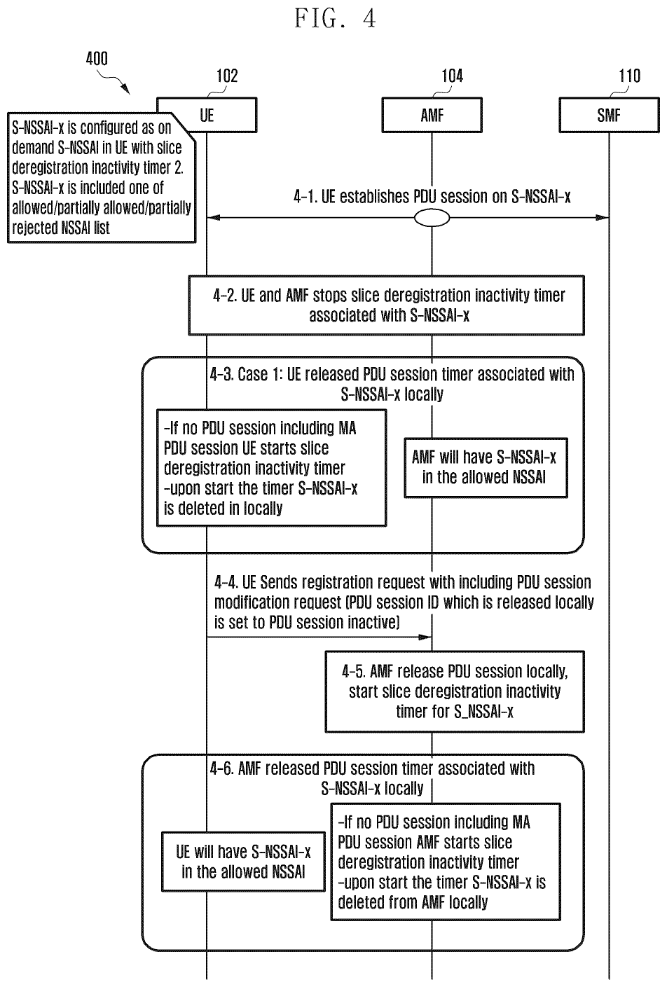

FIG. 4 illustrates a sequence diagram 400 for a scenario, where the UE 102 and network may have the misaligned the slice deregistration inactivity timer for the on-demand S-NSSAI, according to an embodiment of the disclosure.

Considering that, an S-NSSAI-x is on-demand S-NSSAI. The AMF (or NF) 104 has configured on-demand S-NSSAI-x with the slice deregistration inactivity timer (the AMF sends On-demand S-NSSAI to the UE in REGISTRATION ACCEPT or UE CONFIGURATION UPDATE COMMAND by including On-demand S-NSSAI (e.g., S-NSSAI-x) in the On-demand NSSAI IE). There can are cases where UE and/or AMF release PDU session locally. In this case, it may be possible that the entity releasing PDU session locally (e.g. UE) start slice deregistration inactivity timer while other entity (e.g., the AMF) have the PDU session so the other entity doesn't start the slice deregistration inactivity timer. This leads to a synchronization issue between the UE and the AMF. Some possible cases are described below.
1) The S-NSSAI-x is an allowed S-NSSAI in the UE but S-NSSAI-x is removed from the AMF due to the slice deregistration inactivity timer.
2) The S-NSSAI-x is in allowed S-NSSAI in the AMF but S-NSSAI-x is removed from the UE due to the slice deregistration inactivity timer.

In operation 4-1, the S-NSSAI-x is configured as On-demand S-NSSAI in UE with slice deregistration timer 2. Here, the message may be sent to SMF 110. Further, the S-NSSAI-x is at least included in the one of the Allowed NSSAI list/Partially Allowed NSSAI list/Partially rejected NSSAI list. In operation 4-2, the UE 102 initiated PDU session establishment request on the S-NSSAI-x and successful, the UE and the AMF will stop the running slice deregistration inactivity timer.

In a first scenario, in operation 4-3, the UE 102 locally released PDU session associated with S-NSSAI-x. This reason could be the UE 102 is in the no service and wants to release the PDU session. After the retrial, the UE 102 will release the PDU session locally. As the PDU session is released at the UE 102, the UE 102 will start slice deregistration inactivity timer in the UE for the S-NSSAI-x. Upon slice deregistration inactivity timer expiry, the UE will delete (or remove) the S-NSSAI-x from the allowed NSSAI. AMF will continue to maintain S-NSSAI-x in the allowed NSSAI.

In operation 4-4, when the UE 102 sends the registration request to the AMF including PDU session status IE with PDU session ID which is released locally, the UE is set to PDU SESSION INACTIVE.

In operation 4-5, the AMF 104 releases the PDU session locally and start slice de-registration inactivity timer. In the current art, there is no mechanism currently to indicate that the UE doesn't have S-NSSAI-x in the allowed NSSAI when the UE stays in the registered TAI.

Suppose in operation 4-5, the AMF 104 has elapsed Y minutes and then the UE requested S-NSSAI-x in the requested NSSAI. The UE 102 receives the S-NSSAI-x in the allowed NSSAI. If there is no PDU session associated with S-NSSAI-x then the UE 102 will start the slice deregistration inactivity timer. As can be seen that, there will be different timer running at the UE and the AMF which will be expiring not the same time so again, the UE 102 and the AMF 104 may not have the S-NSSAI-x in the allowed NSSAI at the same time.

In operation 4-6, the AMF104 releases the PDU session locally, in this case, the AMF will start slice deregistration inactivity timer associated with S-NSSAI-x but UE does not start the timer, as it is not aware of the PDU session release. There are many cases where the AMF 104 releases the PDU session locally (e.g. when UE in the no service, or the UE in the restricted area where S-NSSAI is not allowed, or the UE in a cell which is in NS-AoS for which S-NSSAI-x is not allowed, partially allowed etc.).

As the AMF 104 has started Slice deregistration timer, so it will remove the S-NSSAI-x from allowed NSSAI after timer expiry. This will lead to UE and AMF have the different allowed NSSAI; i.e., in this case S-NSSAI-x is in allowed NSSAI in the UE but S-NSSAI is not in the allowed SNNSAI in the AMF.

If the UE 102 initiates PDU session establishment request. As S-NSSAI is not in the allowed NSSAI at the AMF side, the AMF will not be able to handle the request.

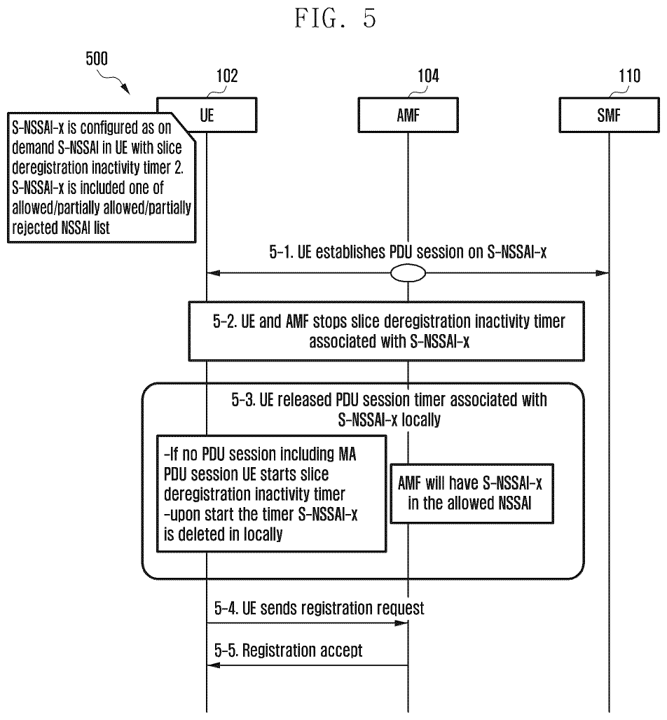

FIG. 5 illustrates a sequence diagram 500 for a scenario, where the UE removes S-NSSAI from the allowed S-NSSAI locally, according to an embodiment of the disclosure.

At operation 5-1, the UE 102 and the AMF 104 establishes a PDU session on S-NSSAI-x. Here, the message may be send to the SMF 110. Slice deregistration inactivity timer will be stopped at both UE and the AMF for the S-NSSAI-x. At operation 5-2, the UE 102 locally releases the PDU session associated with S-NSSAI-x.

At operation 5-3, the UE 102 will start the PDU session inactivity timer at the UE side. On slice deregistration timer expiry, the UE 102 will delete S-NSSAI-x from the allowed S-NSSAI. As the PDU session release is local to the UE, so AMF will not start the slice deregistration inactivity timer at the AMF for the S-NSSAI-x.

At operation 5-4, the UE 102 initiates the registration (e.g., or the PDU synchronization). This point, the AMF will know that PDU session is released at the UE so the AMF too will release PDU session locally. On the UE side, S-NSSAI-x is removed from allowed NSSAI but AMF will remove the slice S-NSSAI-x after the slice inactivity de-registration timer expiry if the UE has not included requested NSSAI. If next time, the UE 102 sends the requested NSSAI including S-NSSAI-x, the AMF will send the slice S-NSSAI-x in the allowed NSSAI. The UE will start timer here. So, there will synchronization issue with slice deregistration timer running at the UE and the AMF.

In operation 5-5, the AMF 104 sends to the UE 102 a message indicating registration acceptance.

The requested NSSAI is included in mobility registration only when below condition is met:
1) For a REGISTRATION REQUEST message with a 5GS registration type IE indicating “mobility registration updating”, if the UE:
i) is in NB-N1 mode and:
a) the UE needs to change the slice(s) it is currently registered to within the same registration area; or
b) the UE has entered a new registration area; or
ii) is not in NB-N1 mode and is not registered for onboarding services in SNPN;
the UE shall include the Requested NSSAI IE containing the S-NSSAI(s) corresponding to the network slices to which the UE intends to register and associated mapped S-NSSAI(s).

As the above condition is may not met and the UE is in the same registration area and initiating the mobility registration request (e.g. for the PDU synchronization).

As UE doesn't send the requested NSSAI, so the AMF will initiate the slice inactivity timer after PDU session status is sent along with service request or registration request for the PDU session associated with S-NSSAI-X set to PDU SESSION INACTIVE.

Hence, there is a need in the art for solutions which will overcome the above mentioned drawback(s), among others.

The principal object of embodiments herein is to disclose methods and a system for handling mismatch of allowed S-NSSAIs in a wireless network.

Another object of embodiments herein is to disclose methods and a system for handling a slice deregistration inactivity timer of on-demand S-NSSAIs.

Another object of embodiments herein is to disclose methods and a system for handling of slice deregistration inactivity timer of on-demand S-NSSAIs, when unavailability period is activated in a UE.

Another object of embodiments herein is to disclose methods and a system for handling of S-NSSAI mismatch when UE intersystem moves from 5GC network to EPC network.

Another object of embodiments herein is to disclose methods and a system for handling of allowed S-NSSAI mismatch, when the AMF removes the S-NSSAI from the allowed NSSAI.

Another object of embodiments herein is to disclose methods and a system for handling allowed S-NSSAI mismatch, when the UE removes S-NSSAI from the allowed S-NSSAI locally.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

FIG. 6 illustrates a sequence diagram 600, for a method for handling of N-SSAI mismatch in a wireless network, when a user plane corresponding to a PDU session is released, according to an embodiment of the disclosure.

In an embodiment herein, the PDU session can be released by at least one of, a UE 102 and an AMF 104 in a 5G network.

At operation 6-1, the method comprises, a registration procedure of the UE 102 over a 3GPP access type in a wireless communication network. An AMF-1 104 is receiving a registration request for enabling initiation of a PDU session from the UE 102, and the AMF-1 104 accepts the registration request and configured the UE with a list of allowed S-NSSAIs (e.g., a S-NSSAI-x and so on), wherein the UE 102 received the list of allowed S-NSSAI-s from the AMF-1 104. In an embodiment herein, the AMF-1 104 can further, configure and send to UE on-demand NSSAI IE including list of S-NSSAI and a slice deregistration inactivity timer associated with each of the S-NSSAI.

At operation 6-2, the method comprises, executing by the UE 102 and the AMF-1 104 to start a slice deregistration inactivity timer for a slice S-NSSAI-x on 3GPP-A.

At operation 6-3, the method comprises, a registration procedure of the UE 102 over a non-3GPP access type in a wireless communication network. An AMF-2 104 is receiving a registration request for enabling initiation of a PDU session from the UE 102, and the AMF-2 accepts the registration request and configured the UE 102 with a list of allowed S-NSSAIs (e.g., a S-NSSAI-x and so on), wherein the UE 102 received the list of allowed S-NSSAI-s from the AMF-2 106. In an embodiment herein, the AMF-2 106 can further, configure, and send to UE on-demand NSSAI IE including list of S-NSSAI and slice deregistration inactivity timer associated with each of the S-NSSAI.

At operation 6-4, the method comprises, executing by the UE 102 and the AMF-1 104 to start a slice deregistration inactivity timer for a slice S-NSSAI-x on non-3GPP-A.

At operation 6-5, the method comprises, requesting by the UE 102 for establishment of a PDU session of MA-PDU session type with the AMF-1 104 or upgrade of a PDU session to an MA PDU session.

At operation 6-6, the method comprises, accepting by the AMF-1 104, the PDU session establishment request. In an embodiment herein, the PDU session establishment is successful with say, Access Traffic Steering, Switching, and Splitting (ATSSS) parameter. The UE 102 therefore, considers MA-PDU session is successful and stops the slice deregistration inactivity timer for S-NSSAI-x on both the 3GPPA and the non-3GPPA access types, when both the 3GPPA and the non-3GPPA access types are on same PLMN.

At operation 6-7, the AMF-1 104 stops the slice deregistration inactivity timer for S-NSSAI-x on the 3GPPA. At operation 6-8, the UE 102 experiences no user plane is established over non-3GPPA. At operation 6-9, the UE 102 transmits a request to the AMF-2 106, for establishment of, a PDU session and a user plane for the PDU session. In this step, UE and AMF stops the slice deregistration inactivity timer for S-NSSAI-x over the non-3GPPA.

At operation 6-10, the AMF-1 104 transmits to the UE 102, a PDU session release command, for the access type 3GPP-A. The UE 102 starts the slice deregistration inactivity timer for the network slice S-NSSAI-x on the 3GPPA access type.

In an embodiment herein, when the UE 102 is registered on 3GPPA access type and non-3GPPA access type on same PLMN, the UE 102 can stop the slice deregistration inactivity timer for both 3GPPA and non-3GPPA for the S-NSSAI-x when the MA PDU session is established. Optionally, the UE 102 stops the slice deregistration inactivity timer for the access type (e.g., 3GPPA) over which UE-requested PDU session establishment procedure is sent to initiate an MA PDU session or where the UE send PDU session modification comments to upgrade session to MA PDU session but for the other access (e.g., Non-3GPPA) after an indication of user plane is established. The UE 102 stops the slice deregistration inactivity timer on the non-3GPPA after receiving the user plane establishment indication. When the UE 102 initiates PDU session establishment request for the user plane establishment; i.e., slice deregistration timer is stopped and reset over the access type when at least a PDU session, including any MA PDU session, associated with the S-NSSAI or user plane of MA PDU is successfully established over the corresponding access type(s). Further, in an embodiment herein, the slice deregistration timer is stopped and reset over the access type when the S-NSSAI is removed from the allowed NSSAI; i.e., the UE 102 stops the slice inactivity deregistration timer for the access (access-1, e.g., Non-3GPPA) where it received the user plane established indication and UE has send the PDU session establishment request or PDU session modification command on the other access for establishing MA PDU session (say access-2 e.g., 3GPPA). In an embodiment herein, the UE 102 determines MA PDU session release or user plane resource release based on the below condition.

For an MA PDU session, upon receipt of the PDU SESSION RELEASE COMMAND message, the UE 102 shall behave as follows:
a) if the PDU SESSION RELEASE COMMAND message includes an Access type information element (IE) and the MA PDU session has user-plane resources established on both 3GPP access and non-3GPP access, the UE 102 shall consider the user-plane resources on the access indicated in the Access type IE as released and shall create a PDU SESSION RELEASE COMPLETE message. If the Access type IE indicates “3GPP access” and there is one or more multicast MBS sessions associated with the MA PDU session, the UE 102 shall locally leave these associated multicast MBS sessions;
b) if the PDU SESSION RELEASE COMMAND message includes the Access type IE and the MA PDU session has user-plane resources established on only the access indicated in the Access type IE, the UE 102 shall consider the MA PDU session as released and shall create a PDU SESSION RELEASE COMPLETE message; and
c) if the PDU SESSION RELEASE COMMAND message does not include the Access type IE, the UE 102 shall consider the MA PDU session as released and shall create a PDU SESSION RELEASE COMPLETE message.

In an embodiment herein, the UE 102 takes the below action on receiving PDU session release command or local release of PDU session associated with stored on-demand S-NSSAI with slice de-registration inactivity timer in the UE 102, they are,
a) When the PDU session associated with an on-demand S-NSSAI is released and there is no MA PDU session associated with this on-demand S-NSSAI present or no PDU session associated with an on-demand S-NSSAI present, or no user plane resources associated with on-demand S-NSSAI over the access present, the UE 102 shall start the slice deregistration inactivity timer for this on-demand S-NSSAI over the corresponding access type;
b) When, the MA PDU session associated with an on-demand S-NSSAI are released, for each registered access, if there is no PDU session associated with this on-demand S-NSSAI present, or no user plane established for an MA PDU session associated with on-demand S-NSSAI (optionally there is no MA PDU session associated with the on-demand S-NSSAI) is present. The on-demand S-NSSAI is in the allowed NSSAI and the on-demand S-NNSAI have the associated slice deregistration inactivity timer over the access type. The UE 102 in this scenario shall start the slice deregistration inactivity timer for this on-demand S-NSSAI over the access.
c) When, user-plane resources of MA PDU session associated with on-demand S-NSSAI is released on an access (say access-1) and there is no PDU session associated with this on-demand S-NSSAI (over access-1) or no user plane resources associated with on-demand S-NSSAI over the access (Access-1) is present or optionally there is no MA PDU session associated with this on-demand S-NSSAI, then UE 102 shall start the slice deregistration inactivity on the access (Access-1) if the on-demand S-NSSAI is in the allowed NSSAI or partially allowed NSSAI.

Alternatively, if the UE 102 is configured with on-demand S-NSSAI including slice deregistration inactivity timer, the following events occur:
a) if the PDU session associated with an on-demand S-NSSAI is released and there is no established user plane resources of an MA PDU session associated with this on-demand S-NSSAI and there is no PDU session associated with this on-demand S-NSSAI, the UE 102 shall start the slice deregistration inactivity timer for this on-demand S-NSSAI over the corresponding access type;
b) if the MA PDU session associated with an on-demand S-NSSAI is released:
   for each registered access type, if there is no PDU session associated with this on-demand S-NSSAI and there is no established user plane resources of an MA PDU session associated with this on-demand S-NSSAI over the access (registered access type), the UE 102 shall start the slice deregistration inactivity timer for this on-demand S-NSSAI over the access (registered access type); or
c) if the User plane resources of MA PDU session associated with an on-demand S-NSSAI is released over the access type and there is no PDU session associated with this on-demand S-NSSAI and there is no established user plane resources of an MA PDU session associated with this on-demand S-NSSAI over the corresponding access type then UE 102 shall start the slice deregistration inactivity over the corresponding access type.

In this embodiment, registered access type means the UE 102 on the access is registered with the network (say, UE is register with the network over the access type 3GPPA or non-3GPPA).

In this specification, when PDU session is not an MA PDU session then it is single access PDU session.

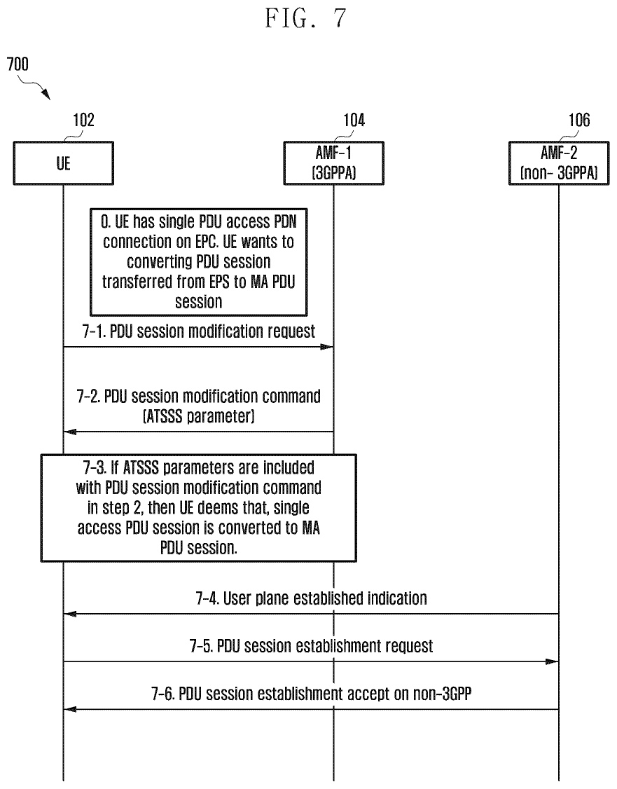

FIG. 7 illustrates a sequence diagram 700, for a method for handling of N-SSAI mismatch in a wireless network, for a scenario where slice deregistration inactivity timer corresponding to an on-demand S-NSSAI is stopped, on a user plane being established, according to an embodiment of the disclosure.

The UE 102 has a single PDU access Packet data network (PDN) connection on EPC. A network slice S-NSSAI-x is in allowed NSSAI in non-3GPP and is on-demand S-NSSAI on both 3GPP and non-3GPP access. The UE 102 wants to convert the PDU session from EPS to MA PDU session. The PDU session modification request with ATSSS parameters is sent to an AMF-1 and the UE 102 may set the Request type IE to either:
a) modification request” and include the MA PDU session information IE set to “MA PDU session network upgrade is allowed” as defined in clause 9.11.3.31A of 3GPP TS 24.501; or
b) “MA PDU request.”

When the network deems that MA PDU session can be converted, it sends the PDU session medication command with ATSSS parameters. The UE 102 then consider that as single PDU session is upgraded to MA PDU session. If 3GPP and non-3GPP are on the same PLMN then UE 102 may receive the user plane setup indication. In this case UE 102 is not stopping the slice deregistration inactivity timer running on the non-3GPP for the S-NSSAI-x.

At operation 7-1, the UE 102 sends a PDU session modification request to the AMF-1 104. At operation 7-2, the AMF-1 1 sends, a PDU session modification command with ATSSS parameter, to the UE. At operation 7-3, UE 102 deems that, a single access PDU session is converted to MA PDU session, when ATSSS parameters are included with PDU session command. A user plane is established on 3GPPA.

At operation 7-4, the UE 102 upon receiving user plane setup stop the slice deregistration inactivity timer on non-3GPP access for the on demand S-NSSAI-x, if the timer is running. At operation 7-5, the UE 102 sends a PDU session establishment request to an AMF-2. At operation 7-6, the AMF-2 send to the UE, a PDU session establishment accept message and establishes a user plane on non-3GPPA for the PDU session.

In an embodiment herein, when the single access PDU session converted to MA PDU session associated with on-demand S-NSSAI (e.g., S-NSSAI-x) successfully, then the UE shall stop the slice inactivity timer associated with on-demand S-NSSAI-x on the 3GPPA (i.e. on the access where PDU session modification request is sent). The UE shall stop the slice deregistration inactivity timer associated with on-demand S-NSSAI-x for the non-3GPP (on the access where PDU session modification request is not sent) when the UE, received the user plane established indication for the S-NSSAI-x.

Optionally, when single access PDU session is converted to MA PDU session, the UE shall stop the slice inactivity deregistration timer on both the access (3GPPA and non-3GPPA), if running for the S-NSSAI-x (S-NSSAI which is used for the MA PDU session).

Optionally, when the single access PDU session is converted to MA PDU session associated with on-demand S-NSSAI-x and the 3GPP and non-3GPP on the same PLMN, the UE 102 shall stop the slice inactivity deregistration timer on both the access, if running for the S-NSSAI-x (S-NSSAI which is used for the MA PDU session) and when on the 3GPP and non-3GPP access on different PLMN, the UE 102 shall stop the slice deregistration inactivity timer associated with the on-demand S-NSSAI-x over the access where user plane is setup/established (e.g. the UE shall stop the slice deregistration inactivity timer associated with S-NSSAI-x over the non-3GPP access when the user plane is established associated with S-NSSAI-x on non-3GPP access).

In this embodiment, when the MA PDU session is established (either due to initial PDU session establishment request or PDU session modification to convert single access PDU session to MA PDU session) on S-NSSAI-x which is on-demand S-NSSAI.

The UE 102 and the AMF 104 shall stop the slice deregistration inactivity timer on the access where PDU session establishment or PDU session modification request is sent (consider it is sent over 3GPPA then UE shall stop slice deregistration inactivity timer for the S-NSSAI-x on 3GPPA), if the timer is running. The UE 102 shall stop the slice deregistration inactivity for the S-NSSAI-x on other access (here non-3GPPA) when the UE 102 receives the user plane setup or established indication. The AMF-2 106 shall stop the slice deregistration inactivity for the S-NSSAI-x on other access (here non-3GPP) when the UE 102 sends the user plane setup on non-3GPP.

It is assumed that the UE 102 is registered on both the 3GPP and non-3GPPA and S-NSSAI-x is on-demand NSSAI on both the access and configured with slice inactivity de-registration timer.

Optionally, the UE and the AMF shall stop the slice inactivity deregistration timer on both the access (3GPPA, non-3GPPA) for S-NSSAI-x when on the same PLMN (i.e., 3GPPA and non-3GPPA on the same PLMN). On different PLMN.

If the 3GPPA and non-3GPP on the different PLMN, the UE 102 shall stop the slice deregistration inactivity for the S-NSSAI-x on other access (here non-3GPPA) when it receive the user plane setup/established indication and the AMF shall stop the slice deregistration inactivity for the S-NSSAI-x on other access (here non-3GPP) when it is send the user plane setup on non-3GPP (i.e., when sending PDU session establishment accept).

In yet another embodiment, when PDU session establishment is accepted by the UE/network on the on-demand NSSAI.
a) a PDU session is successfully established for the on-demand S-NSSAI, the UE shall stop and reset the slice deregistration inactivity timer for the on-demand S-NSSAI over corresponding access type, if running;
b) an MA PDU session is successfully established for the on-demand S-NSSAI, the UE 102 shall stop and reset the slice deregistration inactivity timer for the on-demand S-NSSAI over which the user plane is established, if running. Alternatively, an MA PDU session is successfully established for the on-demand S-NSSAI, the UE 102 shall stop and reset the slice deregistration inactivity timer for the on-demand S-NSSAI over access over which on-demand MA PDU session is established; and
c) User plane for MA PDU session is successfully established for the on-demand S-NSSAI, the UE 102 shall stop and reset the slice deregistration inactivity timer for the on-demand S-NSSAI over which the user plane is established.

In yet another embodiment, the UE 102 shall stop the slice inactivity deregistration timer associated with on-demand S-NSSAI-x over the access type where user plane is established (i.e., over the 3GPPA when the user plane is established over 3GPPA, over the non-3GPP access when the user plane is established on non-3GPP access. The user plane establishment is specified in the TS 24.193.

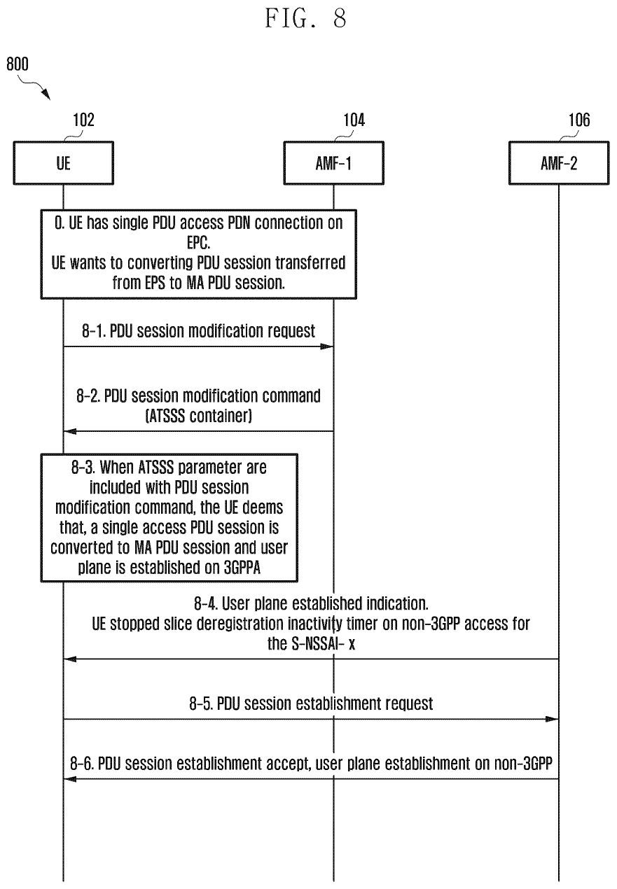

FIG. 8 illustrates a sequence diagram 800, for a method for handling of N-SSAI mismatch in a wireless network, for a scenario, where inactivity deregistration timer is not stopped when a UE moves to EPC or any other RAT, according to an embodiment of the disclosure.

The network slice S-NSSAI-x is on-demand S-NSSAI with slice deregistration inactivity timer stored in the UE 102 (e.g., say 30 mins is the timer value). The UE 102 is registered in N1 mode (in 5GS) over 3GPPA and the slice deregistration inactivity timer is running for the slice S-NSSAI-x. The S-NSSAI-x is in the allowed NSSAI.

At operation 8-1, the UE 102 intersystem changes to S1 mode, i.e. the UE 102 moves to EPC, and tracking area update is successfully performed. The UE 102 is successfully registered on EPC.

At operation 8-2, the MME 108 fetches the context from the AMF 104 (N26 interface is supported for seamless handover of PDU session between EPC and 5GC). However, as the MME 108 cannot fetch the running slice deregistration inactivity timer. The AMF 104 can maintain context for some time based on implementation but whether the slice deregistration inactivity shall be running or stopped at the AMF 104 is not specified. In this embodiment, when the UE intersystem changes to S1 mode (i.e., when the UE performs inter-system change from N1 mode to S1 mode and the UE 102 successfully completes tracking area update procedure) and the tracking update area is procedure is successfully completed (UE receive tracking area update accept), UE context will transfer from the AMF 104 to the MME 108. In this case, the AMF 104 shall stop the slice deregistration inactivity timer for the UE 102.

At operation 8-3, the UE 102, stops the slice deregistration inactivity timer running on the 3GPPA, upon receiving tracking area update accept (when the UE performs inter-system change from N1 mode to S1 mode and UE successfully completes tracking area update procedure).

At operation 8-4, the UE 102 intersystem changes to the N1 mode (5GC) after 10 mins from the time the timer starts for a duration of 30 mins in the beginning. The AMF 104 sends the allowed NSSAI (S-NSSAI-1). As, it is not specified if the AMF 104 will start a new timer, when the AMF 104 stops the running timer and the UE 102 continues with the running timer then there will be misalignment between the UE 102 and the AMF 104 slice deregistration timer when the UE 102 is back to N1 mode.

When the UE 102 comes back to the 5GC and the S-NSSAI-x is added to the allowed NSSAI, the UE 102 and the AMF 104 shall start the slice deregistration timer on S-NSSAI-x on 3GPPA if the S-NSSAI-x.

At operation 8-5, the UE 102 starts slice deregistration inactivity timer, when the UE 102 moves to 5GC from EPC. At operation 8-6, the AMF 104 starts slice deregistration inactivity timer, when the UE move to 5GC from EPC.

In an embodiment herein, the slice S-NSSAI-x is on-demand S-NSSAI with slice deregistration inactivity timer stored in the UE 102 (say 30 mins). The UE 102 is registered in N1 mode (in 5GS) over 3GPPA and slice deregistration timer is running for S-NSSAI-x. The S-NSSAI-x is in the allowed NSSAI.

The UE intersystem changes to EPC, and tracking area update has been successfully performed. The MME 108 fetches the context from the AMF 104 (N26 is supported). The MME 108 cannot fetch the running slice inactivity deregistration timer. In this case, the AMF 104 can maintain context for some time based on the implementation. The AMF 104 stops the slice deregistration inactivity timer. The UE 102 stops slice deregistration inactivity timer over the 3GPPA. The UE intersystem changed to the N1 mode (5GC). The AMF 104 sends the allowed NSSAI (S-NSSAI-1). It is not specified if the AMF 104 will start the new timer.

In this embodiment, when the UE intersystem changed to S1 mode (when the UE performs inter-system change from N1 mode to S1 mode and UE successfully completes tracking area update procedure) and the tracking update area is procedure is successfully completed (UE receive tracking area update accept), the UE context will transfer from the AMF 104 to the MME 108. In this case, the AMF 106 shall stop the slice deregistration inactivity timer for the UE 102 running for 3GPPA.

Upon receiving tracking area update accept (when the UE performs inter-system change from N1 mode to S1 mode and UE successfully completes tracking area update procedure), the UE 102 stops the slice deregistration inactivity timer running on the 3GPPA.

When the UE 102 comes back to the 5GC and the S-NSSAI-x is added to the allowed NSSAI, the UE 102 and the AMF 104 shall start the slice deregistration timer on S-NSSAI-x on 3GPPA if the S-NSSAI-x.

Consider that the S-NSSAI-x is on-demand NSSAI, the AMF includes S-NSSAI-x in the allowed NSSAI. The UE 102 and the AMF 104 starts the slice deregistration inactivity timer. The AMF 104 and the UE 102 shall start the slice deregistration inactivity timer on an access (say access-1), if not running on an access (say access-1) when on-demand S-NSSAI is added in the allowed or partially allowed NSSAI on an access (Access-1) and there is no PDU session or user plane resources established associated with S-NSSAI on the access (access-1). Upon slice deregistration timer expiry, the UE 102 and the AMF 104 remove the S-NSSAI from the allowed and Partially allowed NSSAI. It is assumed here that S-NSSAI is on-demand S-NSSAI with slice deregistration inactivity timer stored in the UE 102. S-NSSAI is in the allowed NSSAI.

Consider that S-NSSAI-x is on-demand S-NSSAI on 3GPPA, and S-NSSAI-x in the allowed NSSAI on the 3GPPA. The slice deregistration inactivity timer for S-NSSAI-x is running on the 3GPPA. When, the UE 102 to report unavailability to the network, the UE 102 can indicate unavailability to the network through registration procedure or deregistration procedure. When the UE 102 activates the unavailability period using registration procedure, then after successful completion of the procedure the UE 102 shall enter the state 5GMM-REGISTERED.NO-CELL-AVAILABLE and may deactivate Access Stratum (AS) layer. When the UE 102 activates the unavailability period using the de-registration procedure, then after successful completion of the procedure the UE 102 shall enter the state 5GMM-DEREGISTERED.NO-CELL-AVAILABLE and deactivate the AS layer.

In an embodiment herein, the Slice deregistration inactivity timer shall continue in the UE 102 and the AMF 104 when unavailability is activated through the registration procedure. The associated procedure associated with Slice deregistration inactivity timer continue in the UE and the network (for an example, UE and the AMF remove the on-demand S-NSSAI-x from allowed NSSAI when the slice deregistration inactivity timer associated with S-NSSAI-x is expired and UE is still unavailable).

In an embodiment herein, the slice deregistration timer shall stop in the UE 102 and the AMF 104 when unavailability is indicated through the de-registration procedure.

In this specification, it is assumed that AMF 104 has included on-demand S-NSSAI with the slice deregistration inactivity timer. If the timer is not included, the UE 102 will not start.

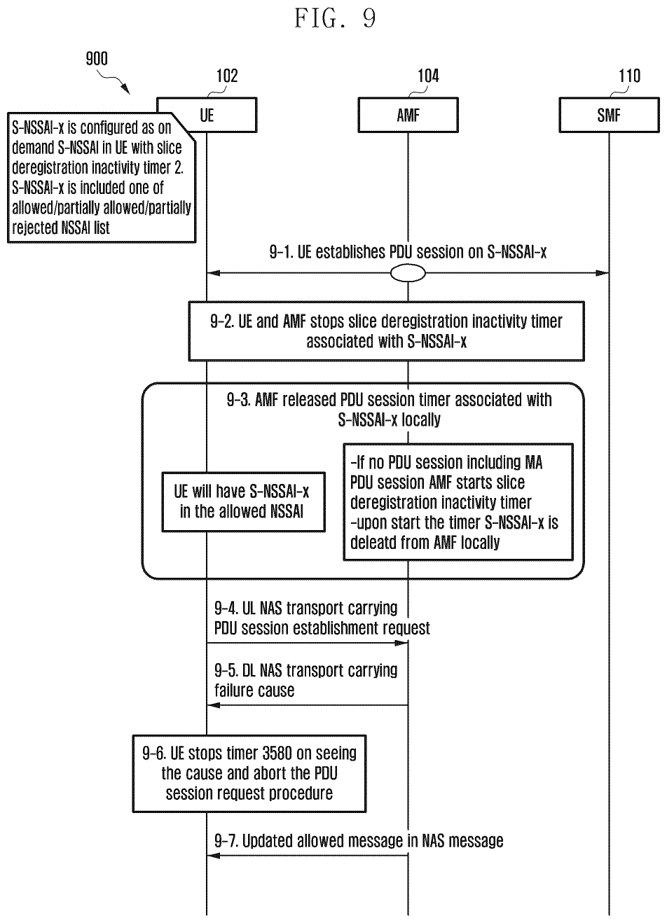

FIG. 9 illustrates a sequence diagram 900, for a method for handling of N-SSAI mismatch in a wireless network, for a scenario, where an AMF removes an S-NSSAI from the allowed NSSAI, according to an embodiment of the disclosure.

Initially, the S-NSSAI-x is configured as On-demand S-NSSAI in the UE 102 with slice deregistration timer 2. The slice S-NSSAI-x is at least included in the one of the Allowed NSSAI list/Partially Allowed NSSAI list/Partially rejected NSSAI list.

At operation 9-1, the UE 102 has initiated a PDU session establishment request on the S-NSSAI-x and the PDU session establishment is successful. At operation 9-2, the UE 102 and the AMF 104 will stop the running slice deregistration inactivity timer.

At operation 9-3, the AMF 104 releases the PDU session associated with S-NSSAI-x locally, in this case, the AMF 104 will start slice deregistration timer associated with S-NSSAI-x, where the UE 102 will not start the timer as it is not aware of the PDU session release. There are many cases where the AMF 104 releases the PDU session locally (e.g., UE in the no service). The AMF 104 has started Slice deregistration timer, and removes the S-NSSAI-x from the allowed NSSAI after timer expiry.

At operation 9-4, the UE 102 has the S-NSSAI-x in the allowed NSSAI and initiated PDU session establishment request associated with the S-NSSAI. In an embodiment herein, UL NAS transport is carrying the PDU session establishment request.

At operation 9-5, The AMF 104 sees that S-NSSAI-x is not in the allowed NSSAI, the AMF 104 sends a DL NAS TRANSPORT with existing 5GMM cause or new 5GMM cause, wherein the 5GMM cause or new 5GMM cause is indicating that the message is not forwarded. On receiving the 5GMM cause, the UE 102 shall stop 3480 timer which is maintaining periodical registration of the UE 102 with network. Additionally, the AMF 104 sends an updated allowed NSSAI removing the S-NSSAI-x though UE configuration update or registration accept or any other NAS message. In this embodiment, upon reception of UE initiated NAS transport message (i.e., UL NAS TRANSPORT message) at the AMF, if Payload container type IE is set to “N1 SM information”, the Request type IE is set to “initial request” or “modification request”, or “MA PDU request”, the associated S-NSSAI that the AMF determined through the S-NSSAI IE is an S-NSSAI not in the allowed NSSAI at AMF, the AMF shall send back to the UE 102 the 5GSM message which was not forwarded in the downlink NAS transport (in operation 9-5) message. In an embodiment herein, the downlink NAS transport message is sent with,
a) including the PDU session ID in the PDU session ID IE;
b) set the Payload container type IE to “N1 SM information”;
c) set the Payload container IE to the 5GSM message which was not forwarded; and
d) set the 5GMM cause IE to the 5GMM cause #90 “payload was not forwarded” or new 5GMM cause value (say 5GMMXX).

In this embodiment, the UE 102 on receiving 5GMM cause 90 or 5GMMXX, the UE passes to the 5GSM sublayer an indication that the 5GSM message was not forwarded due to routing failure along with the 5GSM message from the Payload container IE of the DL NAS TRANSPORT message. The UE 102 shall ignore the Back-off timer value IE, if any.

At operation 9-6, the UE 102 stops timer T3580 and shall abort the PDU session request procedure on receiving an indication that the 5GSM message was not forwarded due to routing failure along with a PDU SESSION ESTABLISHMENT REQUEST message with the PDU session ID IE set to the same value as the PDU session ID that was sent by the UE 102.

At operation 9-7, when the AMF 104 receives the UL NAS transport and if the Payload container type IE is set to “N1 SM information”, the Request type IE is set to “initial request” or “modification request”, or “MA PDU request”, the associated S-NSSAI that the AMF 104 determined through the S-NSSAI IE is an S-NSSAI not in the allowed NSSAI at the AMF 104, the AMF 104 sends the UE configuration update command or other NAS message with allowed NSSAI available at the AMF 102.

When the AMF 104 receive the PDU session establishment request with S-NSSSAI-X which is not in the allowed NSSAI, it check whether S-NSSAI-x can be used. If so, the AMF 104 add the S-NSSAI-x in the allowed S-NSSAI and then handle the PDU session establishment request.

The AMF 104 start slice deregistration inactivity timer+X (additional time) for the on-demand S-NSSAI (S-NSSAI-x) to avoid AMF deleting S-NSSAI first from the allowed NSSAI. Here slice deregistration inactivity timer is the timer given to the UE.

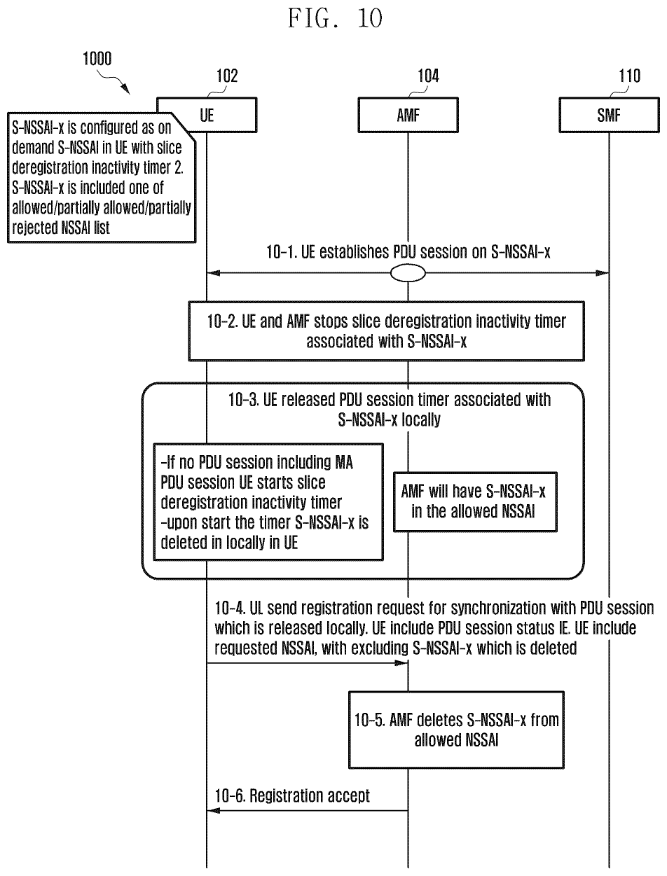

FIG. 10 illustrates a sequence diagram 1000, for a method for handling of N-SSAI mismatch in a wireless network, for a scenario, where a UE 102 removes S-NSSAI from the allowed S-NSSAI locally, according to an embodiment of the disclosure.

At operation 10-1, the UE 102 and the AMF 104 establishes a PDU session on S-NSSAI-x. Here, the message may be sent to SMF 110. At operation 10-2, the slice deregistration inactivity timer will be stopped at both the UE 102 and the AMF 104 for the S-NSSAI-x.

At operation 10-3, the UE 102 locally release PDU session is associated with S-NSSAI-x. the UE 102 will start the PDU session inactivity timer at the UE side. On slice deregistration timer expiry, the UE 102 will delete S-NSSAI-x from the allowed S-NSSAI. As the PDU session release is local to the UE, so the AMF 104 will not start the slice deregistration inactivity timer at the AMF 104 for the S-NSSAI-x.

At operation 10-4, if the UE 102 is sending a registration request with 5GS registration type IE indicating “mobility registration updating” then the UE 102 shall include the Requested NSSAI IE containing the SNSSAI(s) corresponding to the network slices to which the UE 102 intends to register and associated mapped S-NSSAI(s). When S-NSSAI is removed from the allowed S-NSSAI locally i.e. for a REGISTRATION REQUEST message with a 5GS registration type IE indicating “mobility registration updating”, if the UE 102,
a) is in NB-N1 mode and:
1) the UE 102 needs to change the slice(s) it is currently registered to within the same registration area; or
2) the UE 102 has entered a new registration area;
3) the UE 102 locally deletes the S-NSSAI from the allowed NSSAI (due to UE locally release PDU session for the S-NSSAI-x and then the slice deregistration timer for the S-NSSAI-x expiry, S-NSSAI is locally deleted from the allowed NSSAI and the mobility registration initiated),
b) is not in NB-N1 mode and is not registered for onboarding services in SNPN;
the UE 102 shall include the Requested NSSAI IE containing the S-NSSAI(s) corresponding to the network slices to which the UE 102 intends to register and associated mapped S-NSSAI(s).

At operation 10-5, the AMF 104 deletes S-NSSAI-x from the allowed S-NSSAI.

At operation 10-6, the AMF 104 sends to the UE 102 a message indicating registration acceptance.

In this embodiment, when the UE 102 needs to indicate PDU session status to the network after performing a local release of PDU session(s) and the slice inactivity deregistration caused the S-NSSAI associated with PDU session locally released or removed (or deleted) from allowed S-NSSAI, the UE 102 shall include requested NSSAI in the mobility registration (registration request with 5GS registration type IE indicating “mobility registration updating”), optionally until the first mobility registration is successful.

In this embodiment, if the slice inactivity deregistration caused the S-NSSAI associated locally released removed (or deleted) from allowed S-NSSAI, UE shall include requested NSSAI in the mobility registration (registration request with 5GS registration type IE indicating “mobility registration updating”) optionally, until the first mobility registration is successful.

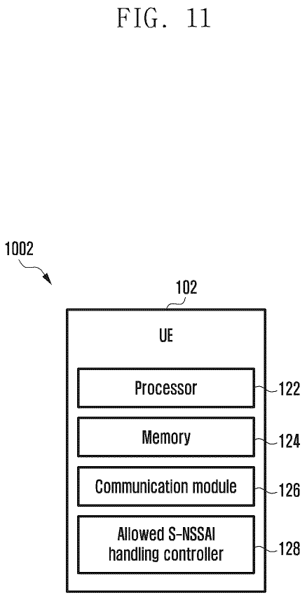

FIG. 11 illustrates a block diagram 1002 of a UE 102, for handling mismatch of an allowed single network slice selection assistance information (S-NSSAI) in a wireless network, according to an embodiment of the disclosure.

In an embodiment herein, the UE comprises, a processor 122, memory 124, a communication module 126, and an allowed S-NSSAI mismatch handling controller 128, coupled with the processor 122 and the memory 124.

In an embodiment herein, the UE 102 can be a portable mobile device such as an electronic equipment with communication facility designed to serve as a medium for facilitating virtual interaction with a network. Further, the UE 102 can be operated by a registered user is a portable electronic device, such as a portable computer, a computing device, a laptop, a smart phone, a desktop computer, a notebook, a Device-to-Device (D2D) device, a vehicle to everything (V2X) device, a foldable phone, a smart TV, a tablet, an immersive device, and an internet of things (IoT) device etc. The UE 102 can include functionality for communicating with the network (say an AMF or an MME) through the communication module 126. In an example embodiment, the UE 102 can be a Smart Phone (iPhone, Android phone, Windows phone), a conventional web-enabled portable computers, a tablet computer or another device capable of communicating through the communication module 126 to connect internet or any other conventional network.

In an embodiment herein, the processor 122 can include analog and/or digital circuits such as logic gates, integrated circuits, microprocessors, microcontrollers, memory circuits, passive electronic components, active electronic components, optical components, hardwired circuits and the like, and may optionally be driven by firmware.

The processor 122 may further, include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 122 may include multiple cores and is configured to execute the instructions stored in the memory 124.

Further, the processor 122 is configured to execute instructions stored in the memory 124 and to perform various processes. The communication module 126 is configured for communicating internally between internal hardware components of the UE 102 and with the network. The memory 124 can also store instructions to be executed by the processor 122. The memory 124 may include non-volatile storage elements. Examples of such non-volatile storage elements may include magnetic hard discs, optical discs, floppy discs, flash memories, or forms of electrically programmable read only memory (EPROM) or electrically erasable and programmable ROM (EEPROM) memories. In addition, the memory 124 may, in some examples, be considered a non-transitory storage medium. The term “non-transitory” may indicate that the storage medium is not embodied in a carrier wave or a propagated signal. However, the term “non-transitory” should not be interpreted that the memory 124 is non-movable. In certain examples, a non-transitory storage medium may store data that can, over time, change (e.g., in Random Access Memory (RAM) or cache).

In an embodiment, the communication module 126 includes an electronic circuit specific to a standard that enables wired or wireless communication. In an example embodiment herein, the communication module (616) may include at least one of the Internet, a wired network (a Local Area Network (LAN), a Controller Area Network (CAN) network, a Universal Asynchronous Receiver/Transmitter (UART), a bus network, Ethernet and so on), a wireless network (a Wi-Fi network, a cellular network, a Wi-Fi Hotspot, Bluetooth, Zigbee and so on using Wireless Application Protocol), a direct interconnection, and so on.

The allowed S-NSSAI mismatch handling controller 128 configures the on-demand S-NSSAI comprising the slice deregistration inactivity timer. Further, the allowed S-NSSAI mismatch handling controller 128 determines that the MA PDU session associated with the on-demand S-NSSAI is released, the PDU session associated with the on-denand S-NSSAI is not available for the registered access, and the established user plane resource of the MA PDU session associated with the on-demand S-NSSAI is not present over the access. Further, the allowed S-NSSAI mismatch handling controller 128 starts the slice deregistration inactivity timer for the on-demand S-NSSAI over the access based on the determination. Further, the allowed S-NSSAI mismatch handling controller 128 handles mismatch of the allowed S-NSSAI in the wireless network based on the slice deregistration inactivity timer.

Further, the allowed S-NSSAI mismatch handling controller 128 stops the slice deregistration inactivity timer. Further, the allowed S-NSSAI mismatch handling controller 128 determines that the user plane of the MA-PDU session associated with the S-NSSAI is successfully established over a corresponding access type. Further, the allowed S-NSSAI mismatch handling controller 128 resets the slice deregistration inactivity timer in at least one of the UE and an Access and Mobility Management Function (AMF) entity when a user plane of the MA-PDU session associated with the S-NSSAI is successfully established over a corresponding access type.

Further, the allowed S-NSSAI mismatch handling controller 128 stops the slice deregistration inactivity timer. Further, the allowed S-NSSAI mismatch handling controller 128 determines that the UE performs inter-system change from a N1 mode to a S1 mode and the UE successfully completes at least one of a tracking area update procedure and an attach request procedure. Further, the allowed S-NSSAI mismatch handling controller 128 resets the slice deregistration inactivity timer in at least one of the UE and an AMF entity when the UB performs inter-system change from the N1 mode to the S1 mode and the UE successfully completes at least one of: the tracking area update procedure and the attach request procedure.

In another embodiment, the allowed S-NSSAI mismatch handling controller 128 configures the on-demand S-NSSAI including the slice deregistration inactivity timer. Further, the allowed S-NSSAI mismatch handling controller 128 determines that the user plane resource of the MA PDU session associated with the on-demand S-NSSAI is released on the access, the PDU session associated with the on-demand S-NSSAI is not present, and the established user plane resource of the MA PDU session associated with the on-demand S-NSSAI over the access is not present. Further, the allowed S-NSSAI mismatch handling controller 128 starts the slice deregistration inactivity timer for the on-demand S-NSSAI over the access based on the determination. Further, the allowed S-NSSAI mismatch handling controller 128 handles the mismatch of the allowed S-NSSAI in the wireless network based on the slice deregistration inactivity timer.

In another embodiment, the allowed S-NSSAI mismatch handling controller 128 determines that an unavailability period is activated through a registration procedure. Further, the allowed S-NSSAI mismatch handling controller 128 starts the slice deregistration inactivity timer in the UE and the AMF entity when the unavailability period is activated. Further, the allowed S-NSSAI mismatch handling controller 128 handles the mismatch of the allowed S-NSSAI in the wireless network based on the slice deregistration inactivity timer. The NAS timer is stopped and associated procedure associated with the at least one NAS timer is aborted except for slice deregistration inactivity timer and its associated procedure. The procedure can be, for example, but not limited to 5GMM common procedures, a 5GMM specific procedures or 5GMM connection management procedures.

In another embodiment, the allowed S-NSSAI mismatch handling controller 128 determines that an on-demand S-NSSAI is added in a partially allowed NSSAI on an access type. Further, the allowed S-NSSAI mismatch handling controller 128 starts the slice deregistration inactivity timer in the UB based on the determination. Further, the allowed S-NSSAI mismatch handling controller 128 handles the mismatch of the allowed S-NSSAI in the wireless network based on the slice deregistration inactivity timer. The partially allowed S-NSSAI is on-demand partially allowed S-NSSAI. The slice deregistration inactivity timer is stated by using a stored slice deregistration inactivity timer value. Further, the allowed S-NSSAI mismatch handling controller 128 stops the slice deregistration inactivity timer when a PDU session is established on the partially allowed NSSAI.

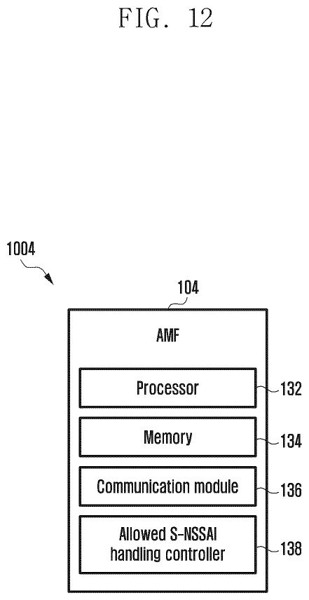

FIG. 12, illustrates a block diagram 1004 of an AMF 104, for handling mismatch of allowed S-NSSAI in a wireless network, according to an embodiment of the disclosure.

In an embodiment herein, the AMF (104) comprises, a processor 132, memory 134, a communication module 136, and an allowed S-NSSAI mismatch handling controller 138, coupled with the processor 132 and the memory 134.

In another embodiment, the allowed S-NSSAI mismatch handling controller 138 determines that an on-demand S-NSSAI is added in a partially allowed NSSAI on an access type. Further, the allowed S-NSSAI mismatch handling controller 138 starts the slice deregistration inactivity timer in the UE based on the determination. Further, the allowed S-NSSAI mismatch handling controller 138 handles the mismatch of the allowed S-NSSAI in the wireless network based on the slice deregistration inactivity timer. The partially allowed S-NSSAI is on-demand partially allowed S-NSSAI. The slice deregistration inactivity timer is stated by using a stored slice deregistration inactivity timer value. Further, the allowed S-NSSAI mismatch handling controller 138 stops the slice deregistration inactivity timer when a PDU session is established on the partially allowed NSSAI.

In an embodiment herein, the processor 132 can include analog and/or digital circuits such as logic gates, integrated circuits, microprocessors, microcontrollers, memory circuits, passive electronic components, active electronic components, optical components, hardwired circuits and the like, and may optionally be driven by firmware.

The processor 132 may further, include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 132 may include multiple cores and is configured to execute the instructions stored in the memory 134.

Further, the processor 132 is configured to execute instructions stored in the memory 134 and to perform various processes. The communication module 136 is configured for communicating internally between internal hardware components of the AMF 104 and with the network. The memory 134 can also store instructions to be executed by the processor 132. The memory 134 may include non-volatile storage elements. Examples of such non-volatile storage elements may include magnetic hard discs, optical discs, floppy discs, flash memories, or forms of EPROM or EEPROM memories. In addition, the memory 134 may, in some examples, be considered a non-transitory storage medium. The term “non-transitory” may indicate that the storage medium is not embodied in a carrier wave or a propagated signal. However, the term “non-transitory” should not be interpreted that the memory 134 is non-movable. In certain examples, a non-transitory storage medium may store data that can, over time, change (e.g., in Random Access Memory (RAM) or cache).

In an embodiment, the communication module 136 includes an electronic circuit specific to a standard that enables wired or wireless communication. In an example embodiment herein, the communication module 136 may include at least one of the Internet, a wired network (a Local Area Network (LAN), a Controller Area Network (CAN) network, a Universal Asynchronous Receiver/Transmitter (UART), a bus network, Ethernet and so on), a wireless network (a Wi-Fi network, a cellular network, a Wi-Fi Hotspot, Bluetooth, Zigbee and so on using Wireless Application Protocol), a direct interconnection, and so on.

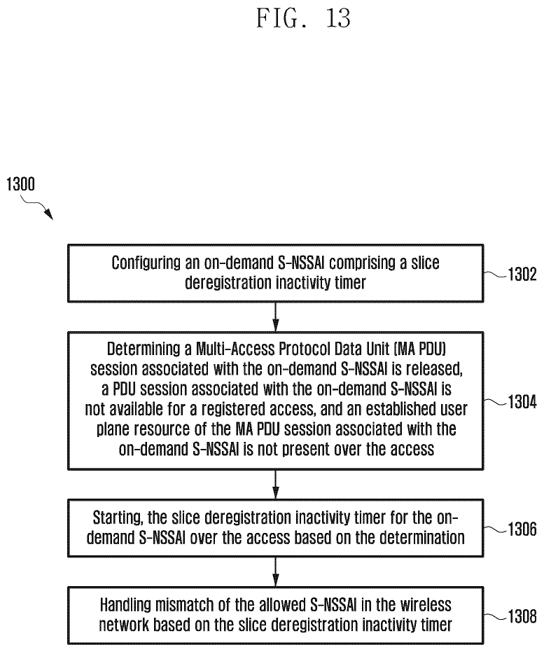

FIGS. 13, 14, 15, and 16 respectively illustrate methods 1300, 1400, 1500, and 1600 for handling, for handling mismatch of the S-NSSAI in the wireless network, according to various embodiments of the disclosure.

FIG. 13 illustrates a method 1300 for handling, for handling mismatch of the allowed S-NSSAI in the wireless network, according to an embodiment of the disclosure.

Referring to FIG. 13, at operation 1302, the method comprises, configuring by a User Equipment (UE) 102, an on-demand S-NSSAI comprising a slice deregistration inactivity timer. At operation 1304, the method comprises, determining by the UE 102, that the MA PDU session associated with the on-demand S-NSSAI is released, a PDU session associated with the on-demand S-NSSAI is not available for a registered access, and an established user plane resource of the MA PDU session associated with the on-demand S-NSSAI is not present over the access.

At operation 1306, the method comprises, starting by the UE 102, the slice deregistration inactivity timer for the on-demand S-NSSAI over the access based on the determination. At operation 1308, the method comprises, handling mismatch of the allowed S-NSSAI in the wireless network based on the slice deregistration inactivity timer.

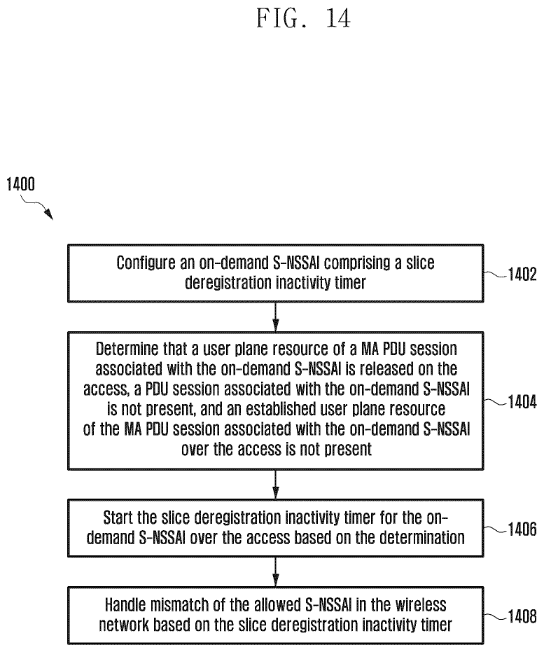

FIG. 14 illustrates a method 1400 for handling, for handling mismatch of the allowed S-NSSAI in the wireless network, according to an embodiment of the disclosure.

Referring to FIG. 14, at operation 1402, the method includes configuring the on-demand S-NSSAI comprising the slice deregistration inactivity timer. At operation 1402, the method includes determining that the user plane resource of the MA PDU session associated with the on-demand S-NSSAI is released on the access, the PDU session associated with the on-demand S-NSSAI is not present, and the established user plane resource of the MA PDU session associated with the on-demand S-NSSAI over the access is not present. At operation 1406, the method includes starting the slice deregistration inactivity timer for the on-demand S-NSSAI over the access based on the determination. At operation 1408, the method includes handling mismatch of the allowed S-NSSAI in the wireless network based on the slice deregistration inactivity timer.

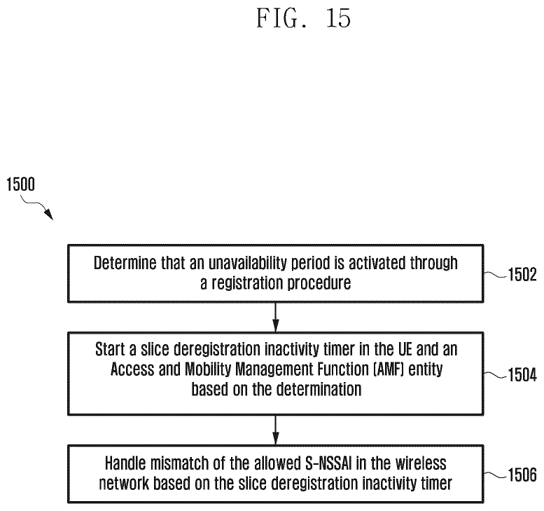

FIG. 15 illustrates a method 1500 for handling, for handling mismatch of the allowed S-NSSAI in the wireless network, according to an embodiment of the disclosure.

Referring to FIG. 15, at operation 1502, the method includes determining that the unavailability period is activated through the registration procedure. At operation 1504, the method includes starting the slice deregistration inactivity timer in the UE and the AMF entity (104) based on the determination. At operation 1506, the method includes handling the mismatch of the allowed S-NSSAI in the wireless network based on the slice deregistration inactivity timer.

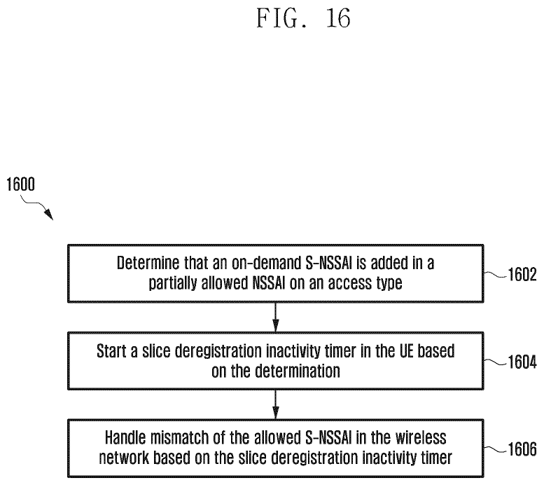

FIG. 16 illustrates a method 1600 for handling, for handling mismatch of the allowed S-NSSAI in the wireless network, according to an embodiment of the disclosure.

Referring to FIG. 16, at operation 1602, the method includes determining that the on-demand S-NSSAI is added in the partially allowed NSSAI on the access type. At operation 1604, the method includes starting the slice deregistration inactivity timer in the UE based on the determination. At operation 1606, the method includes handling the mismatch of the allowed S-NSSAI in the wireless network based on the slice deregistration inactivity timer.

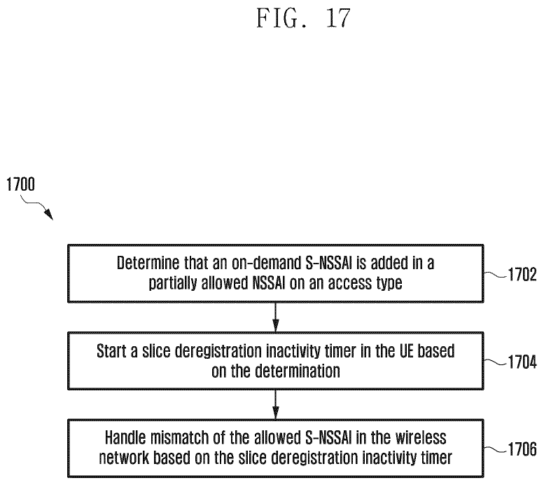

FIG. 17 illustrates a method 1700 for handling, for handling mismatch of an allowed Single network slice selection assistance information (S-NSSAI) in a wireless network for an unavailability period of UE, according to an embodiment of the disclosure.

At operation 1702, the method includes determining that the on-demand S-NSSAI is added in the partially allowed NSSAI on the access type. At operation 1704, the method includes starting the slice deregistration inactivity timer in the UE based on the determination. At operation 1706, the method includes handling the mismatch of the allowed S-NSSAI in the wireless network based on the slice deregistration inactivity timer.

Embodiments herein disclose, handling of S-NSSAI mismatch, if the PDU session associated with an on-demand S-NSSAI is released and there is no established user plane resources of an MA PDU session associated with this on-demand S-NSSAI and there is no PDU session associated with an on-demand S-NSSAI, the UE shall start the slice deregistration inactivity timer for this on-demand S-NSSAI over the corresponding access type.

Embodiments herein disclose, handling mismatch of allowed S-NSSAI when the MA PDU session associated with an on-demand S-NSSAI is released:

For each registered access, if there is no PDU session associated with this on-demand S-NSSAI and there is no established user plane resources of an MA PDU session associated with this on-demand S-NSSAI over the access, the UE 10 shall start the slice deregistration inactivity timer for this on-demand S-NSSAI over the access.

Embodiments herein disclose, handling mismatch of allowed S-NSSAI when user plane resources of MA PDU session associated with on-demand S-NSSAI is released on the access and there is no PDU session associated with this on-demand S-NSSAI and there is no established user plane resources of an MA PDU session associated with this on-demand S-NSSAI over the access then UE (102) shall start the slice deregistration inactivity on the access.

Embodiments herein disclose, handling mismatch of allowed S-NSSAI, when the unavailability period is activated. All NAS timers are stopped and associated procedures aborted except for timers T3512, T3346, T3447, T3448, T3396, T3526, T3584, T3585, T3587, any back-off timers, T3245, T3247, the timer T controlling the periodic search for HPLMN or EHPLMN or higher prioritized PLMNs, and the timer TSENSE controlling the periodic search for PLMNs satisfying the operator controlled signal level threshold (see 3GPP TS 23.122), slice deregistration inactivity timer when the UE (102) activates the unavailability period using registration procedure.

Embodiments herein disclose, handling mismatch of allowed S-NSSAI, with the slice deregistration inactivity timer is started using the stored slice deregistration inactivity timer value as follows: when there is no established PDU session, including any MA PDU session, associated with the S-NSSAI included in the allowed NSSAI or in the partially allowed NSSAI over corresponding access type.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe methods and systems for handling of S-NSSAI mismatch in a wireless network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an application specific integrated circuit (ASIC), or a combination of hardware and software means, e.g., an ASIC and a field programmable gate array (FPGA), or at least one microprocessor and at least one memory with software modules located therein. The method embodiments described herein could be implemented partly in hardware and partly in software. Alternatively, the disclosure may be implemented on different hardware devices, e.g., using a plurality of CPUs.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
transmitting, to an access and mobility management function (AMF), a registration request message;
receiving, from the AMF, a registration accept message for the registration request message, the registration accept message including information on an on-demand single network slice selection assistance information (S-NSSAI), the information on the on-demand S-NSSAI including the on-demand S-NSSAI and a value of a slice deregistration inactivity timer associated with the on-demand S-NSSAI; and
in case that a condition is satisfied, starting the slice deregistration inactivity timer for the on-demand S-NSSAI over an access type, using the value,
wherein the condition is satisfied:
in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or
in case that user plane resources of the MA PDU session are released over the access type, there is no PDU session associated with the on-demand S-NSSAI and there are no established user plane resources of the MA PDU session over the access type.

2. The method of claim 1, further comprising:
removing the on-demand S-NSSAI from an allowed network slice selection assistance information (NSSAI), based on an expiry of the slice deregistration inactivity timer.

3. The method of claim 1, further comprising:
stopping non-access stratum (NAS) timers except for the slice deregistration inactivity timer, based on an unavailability period being activated,
wherein information on the unavailability period is indicated to the AMF during a registration procedure.

4. The method of claim 1,
wherein the terminal supports network slice usage control, and
wherein the on-demand S-NSSAI is included in an allowed network slice selection assistance information (NSSAI) or a partially allowed NSSAI.

5. A method performed by an access and mobility management function (AMF) in a communication system, the method comprising:
receiving, from a terminal, a registration request message;
determining information on an on-demand single network slice selection assistance information (S-NSSAI), the information on the on-demand S-NSSAI including the on-demand S-NSSAI and a value of a slice deregistration inactivity timer associated with the on-demand S-NSSAI; and
transmitting, to the terminal, a registration accept message for the registration request message, the registration accept message including the information on the on-demand S-NSSAI,
wherein, in case that a condition is satisfied, a first slice deregistration inactivity timer for the on-demand S-NSSAI over an access type is started in the terminal, based on the value, and
wherein the condition is satisfied:
in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or
in case that user plane resources of the MA PDU session are released over the access type, there is no PDU session associated with the on-demand S-NSSAI and there are no established user plane resources of the MA PDU session over the access type.

6. The method of claim 1, further comprising:
starting, by the AMF, a second slice deregistration inactivity timer for the on-demand S-NSSAI over the access type, in case that the on-demand S-NSSAI is added to an allowed network slice selection assistance information (NSSAI), there are no PDU sessions associated with the on-demand S-NSSAI over the access type, and a last PDU session associated with the on-demand S-NSSAI over the access type is released; and
removing the on-demand S-NSSAI from the allowed NSSAI over the access type, based on an expiry of the second slice deregistration inactivity timer.

7. The method of claim 6, further comprising:
stopping non-access stratum (NAS) timers except for the second slice deregistration inactivity timer, based on an unavailability period being activated,
wherein information on the unavailability period is obtained from the terminal during a registration procedure.

8. The method of claim 5,
wherein the terminal supports network slice usage control, and
wherein the on-demand S-NSSAI is included in an allowed network slice selection assistance information (NSSAI) or a partially allowed NSSAI.

9. A terminal in a communication system, the terminal comprising:
a transceiver; and
a processor configured to:
control the transceiver to transmit, to an access and mobility management function (AMF), a registration request message,
control the transceiver to receive, from the AMF, a registration accept message for the registration request message, the registration accept message including information on an on-demand single network slice selection assistance information (S-NSSAI), the information on the on-demand S-NSSAI including the on-demand S-NSSAI and a value of a slice deregistration inactivity timer associated with the on-demand S-NSSAI, and
in case that a condition is satisfied, start the slice deregistration inactivity timer for the on-demand S-NSSAI over an access type, using the value,
wherein the condition is satisfied:
in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or
in case that user plane resources of the MA PDU session are released over the access type, there is no PDU session associated with the on-demand S-NSSAI and there are no established user plane resources of the MA PDU session over the access type.

10. The terminal of claim 9, wherein the processor is further configured to:
remove the on-demand S-NSSAI from an allowed network slice selection assistance information (NSSAI), based on an expiry of the slice deregistration inactivity timer.

11. The terminal of claim 9,
wherein the processor is further configured to stop non-access stratum (NAS) timers except for the slice deregistration inactivity timer, based on an unavailability period being activated, and
wherein information on the unavailability period is indicated to the AMF during a registration procedure.

12. The terminal of claim 9,
wherein the terminal supports network slice usage control, and
wherein the on-demand S-NSSAI is included in an allowed network slice selection assistance information (NSSAI) or a partially allowed NSSAI.

13. An access and mobility management function (AMF) in a communication system, the AMF comprising:
a transceiver; and
a processor configured to:
control the transceiver to receive, from a terminal, a registration request message,
determine information on an on-demand single network slice selection assistance information (S-NSSAI), the information on the on-demand S-NSSAI including the on-demand S-NSSAI and a value of a slice deregistration inactivity timer associated with the on-demand S-NSSAI, and
control the transceiver to transmit, to the terminal, a registration accept message for the registration request message, the registration accept message including the information on the on-demand S-NSSAI,
wherein, in case that a condition is satisfied, a first slice deregistration inactivity timer for the on-demand S-NSSAI over an access type is started in the terminal, based on the value, and
wherein the condition is satisfied:
in case that a multi-access (MA) protocol data unit (PDU) session associated with the on-demand S-NSSAI is released for each registered access type, there is no PDU session associated with the on-demand S-NSSAI and there are no established user plane resources of the MA PDU session over the access type, or
in case that user plane resources of the MA PDU session are released over the access type, there is no PDU session associated with the on-demand S-NSSAI and there are no established user plane resources of the MA PDU session over the access type.

14. The AMF of claim 13, wherein the processor is further configured to:
start a second slice deregistration inactivity timer for the on-demand S-NSSAI over the access type, in case that the on-demand S-NSSAI is added to an allowed network slice selection assistance information (NSSAI), there are no PDU sessions associated with the on-demand S-NSSAI over the access type, and a last PDU session associated with the on-demand S-NSSAI over the access type is released; and
remove the on-demand S-NSSAI from the allowed NSSAI over the access type, based on an expiry of the second slice deregistration inactivity timer.

15. The AMF of claim 14,
wherein the processor is further configured to stop non-access stratum (NAS) timers except for the second slice deregistration inactivity timer, based on an unavailability period being activated, and
wherein information on the unavailability period is obtained from the terminal during a registration procedure.
